(19) United States
(12) Patent Application Publication
(10) Pub. No.: US 2017/0071704 A1
(43) Pub. Date: Mar. 16, 2017

(54) HYDRO-MECHANICAL AUTOGRAFTING TOOL AND METHOD OF USE

(71) Applicants: Salah HUWAIS, Jackson, MI (US); Huwais IP Holding LLC, Jackson, MI (US)

(72) Inventor: Salah Huwais, Jackson, MI (US)

(73) Assignee: Huwais IP Holding LLC, Jackson, MI (US)

(21) Appl. No.: 15/125,278

(22) PCT Filed: Mar. 13, 2015
(86) PCT No.: PCT/US2015/020353

§ 371 Date: Sep. 12, 2016

Related U.S. Application Data
(60) Provisional application No. 61/953,415, filed on Mar. 14, 2014.
(60) Provisional application No. 62/007,811, filed on Jun. 4, 2014.

(51) Int. Cl. A61C 8/00; A61C 1/00

(52) U.S. Cl. CPC A61C 8/0089; A61C 8/0033; A61C 1/0061; A61C 2008/0084

(57) ABSTRACT

Methods and tools for expanding a precursor hole in a host material to receive an anchor or fixture. The precursor hole is enlarged by a rotary tool having helical flutes and interposed lands. The lands each have a working edge that densities bone when the tool is rotated in a non-cutting direction. When the tool is used with a copious wash of irrigating fluid, hydraulic pressure builds inside the precursor hole. The operator can modulate the hydraulic pressure by axially stroking the rotating tool. The working edges sweep against the interior surface of the hole to gently expand its diameter by incremental plastic deformations with little to no removal of host material. The host material may be bone and the hole formed may be an osteotomy that is prepared with dense, compacted sidewalls to receive a bone implant with a high degree of primary stability.

### CROSS REFERENCE TO RELATED APPLICATIONS

This application claims priority to Provisional Patent Application No. 61/953,415 filed Mar. 14, 2014, and also claims priority to Provisional Patent Application No. 62/007,811 filed Jun. 4, 2014, the entire disclosures of which are hereby incorporated by reference and relied upon.

### BACKGROUND OF THE INVENTION

Field of the Invention

The invention relates generally to methods for preparing a hole to receive an anchor or fixture in any host material, and in one embodiment the invention more specifically relates to a rotary osteotome and methods implemented thereby for expanding an osteotomy with dense, compacted sidewalls to receive an implant or fixation device.

Description of Related Art

An implant is a medical device manufactured to replace a missing biological structure, to support a damaged biological structure, or to enhance an existing biological structure. Bone implants are implants of the type placed into the bone of a patient. Bone implants may be found throughout the human skeletal system, including dental implants in a jaw bone to replace a lost or damaged tooth, joint implants to replace a damaged joints such as hips and knees, and reinforcement implants installed to repair fractures and remediate other deficiencies, to name but a few. The placement of an implant often requires a preparation into the bone using either hand osteotomes or precision drills with highly regulated speed to prevent burning or necrosis of the bone. After a variable amount of time to allow the bone to grow on to the surface of the implant (or in some cases to a fixture portion of an implant), sufficient healing will enable a patient to start rehabilitation therapy or return to normal use or perhaps the placement of a restoration or other attachment feature.

In the example of a dental implant, preparation of an osteotomy—which is defined as a hole in the bone—is required to receive a bone implant. According to current techniques, at edentulous (without teeth) jaw sites that need expansion, a pilot hole is bored into the recipient bone to form the initial osteotomy, taking care to avoid the vital structures. The pilot hole is then expanded using progressively wider expander devices called osteotomes, manually advanced by the surgeon (typically between three and seven successive expanding steps, depending on implant width and length). Once the receiving hole has been properly prepared, a fixture screw (usually self-tapping) is screwed in at a precise torque so as not to overload the surrounding bone which could result in stripping of the screw threads or fracture of the surrounding bone structure.

The hammered osteotome technique has become widely utilized in certain situations requiring preparation of an osteotomy site by expansion of a pilot hole. By nature, the osteotome technique is a traumatic procedure. Osteotomes are traditionally not rotating devices but rather advanced with the impact of a surgical mallet, which compacts and expands the bone in the process of preparing osteotomy sites that will allow implant placement. Treatment of a mandibular site, for example, is often limited due to the increased density and reduced plasticity exhibited by the bone in this region. Other non-dental bone implant sites may have similar challenging density and plasticity characteristics. Or, the location of the bone may be wholly unsuitable for the violent impact of an osteotome, such as in small bone applications like the vertebrae and hand/wrist areas to name a few. Additionally, since the traditional osteotome is inserted by hammering, the explosive nature of the percussive force provides limited control over the expansion process, which often leads to unintentional displacement or fracture such as in the labial plate of bone in dental applications. The often rapid expansion rate caused by a hammered osteotome subjects the bone structure to stress spikes that exceed the bone's ultimate tensile strength and produces unwanted cracks. Many patients do not tolerate the osteotome technique well, frequently complaining about the impact from the surgical mallet. Furthermore, reports have documented the development of a variety of complications that result from the percussive trauma in dental applications, including vertigo and the eyes may show nystagmus (i.e., constant involuntary cyclical movement of the eyeball in any direction).

If the load on the bone structure imposed by the surgeon in either forming the hole or placing the implant exceeds the bone's ability to deform elastically, the bone will deform and change shape permanently by plastic deformation. If the rate of change is relatively small, the bone yields in a controlled manner while the osteotomy expands. A significant problem with the hammered osteotome is its tendency to abruptly surpass the yield point of the material with any given impact blow by the hammer and translate the affected bone to its point of fracture.

To an extent, the prior art has sought to retain many of the beneficial properties of an osteotomy prepared via hammered osteotome but without all of its drawbacks. For example, U.S. Pat. No. 7,402,040 to Turri discloses a hybrid hammered and rotary osteotome technique using a non-circular dilator design. In Turri's preferred embodiment, the non-circular osteotome is first hammered to the bottom of a precursor hole, and then when at full depth rocked back-and-forth with a hand-crank to achieve a final expansion shape. The felt effects of hammering are diminished by the blade-like apex edges of the tool which cut like chisels into the surrounding bone. The undesirable stress fractures in the bone are thereby limited to the regions of the apex edges which cut into the sidewalls of bone, and patient trauma from pounding is somewhat reduced. Therefore, while Turri does enable some of the bone to be plastically deformed without surpassing the yield point of the bone material, there remain portions of bone (i.e., those portions that are cut by the apex edges of the dilator tool) that are harshly impacted to the point of fracture and the patient experiences some degree of discomfort due to a milder form of hammering and subsequent back-and-forth cranking operation. Furthermore, the techniques disclosed by Turri are, by design, slow and manual and appear to be conducted without any irrigation.

There is therefore a need for improved tools and techniques that prepare bone and other types of host materials to receive an anchor or implant. The improved tools and techniques should facilitate gentle plastic deformation of the bone structure (or other host material) without any fracture, allow the surgeon (or operator) to tactically discern the rate of bone movement at all times and thereby avoid excessive applications of pressure, avoid overheating the bone, minimize patient-sensed trauma and work rapidly so that the surgeon's time is used effectively.

### BRIEF SUMMARY OF THE INVENTION

According to a first aspect of this invention, a method is provided for enlarging a hole in a host material in preparation for an anchor. The method comprises the steps of: providing a precursor hole in a host material, the precursor hole having an interior surface extending between an entrance and a closed bottom. A rotary tool is configured to be turned at high speed. The tool includes a body having an apical end. A plurality of flutes are disposed about the body. A land is formed between each two adjacent flutes. Each land has a land face that leads into a working edge. The method further includes rotating the body of the tool in a non-cutting direction and at a speed greater than 200 RPM, and then inserting the apical end of the rotating body into the entrance of the precursor hole. Meanwhile, the precursor hole is irrigated with a substantially incompressible liquid. The precursor hole is then enlarged by forcibly pushing the rotating body toward the bottom of the precursor hole. The enlarging step includes sweeping the working edges in the non-cutting direction against the interior surface of the precursor hole without cutting the host material in order to plastically deform the host material in a full circular and progressively descending manner beginning at the entrance and developing toward the bottom. The method includes hydraulically preconditioning the host material within the precursor hole prior to contact with a working edge during the sweeping step.

By hydraulically preconditioning the precursor hole, the operator is able to gently pre-stress the host material in preparation for subsequent densifying contact. Preconditioning in this setting also transmits a haptic feedback through the tool that allows the operator to tactically discern the instantaneously applied pressure prior to actual contact between the tool and the side walls of the precursor hole. Furthermore, enhanced hydration of the host structure can increase material toughness and also increase materials plasticity. When the host material has a cellular structure, like foam metal or bone, hydraulic preconditioning assists infusion of host material fragments into the lattice structure of the surrounding material. Other advantages of hydraulic preconditioning include reduced heat transfer and improved hydrodynamic lubricity, among others.

According to another aspect of this invention, a surgical method is provided for enlarging an osteotomy in a bone in preparation to receive an implant or fixture. The method comprises the steps of: providing a precursor osteotomy in a section of bone, the precursor osteotomy having an interior surface extending between an entrance and a closed bottom. A rotary osteotome is configured to be turned at high speed. The osteotome includes a body having an apical end. A plurality of flutes are disposed about the body. A land is formed between each two adjacent flutes. Each land has a land face that leads into a working edge. The method further includes rotating the body of the osteotome in a non-cutting direction and at a speed greater than 200 RPM, and then inserting the apical end of the rotating body into the entrance of the precursor osteotomy. Meanwhile, the precursor osteotomy is irrigated with a substantially incompressible liquid. The precursor osteotomy is then enlarged by forcibly pushing the rotating body toward the bottom of the precursor osteotomy. The enlarging step includes sweeping the working edges in the non-cutting direction against the interior surface of the precursor osteotomy without cutting the bone in order to plastically deform the bone in a full circular and progressively descending manner beginning at the entrance and developing toward the bottom. The method includes hydraulically preconditioning the bone within the precursor osteotomy prior to contact with a working edge during the sweeping step.

The novel hydraulic preconditioning step is particularly effective in surgical procedures where the precursor hole is an osteotomy. In these cases, the surgeon directly benefits from all of the aforementioned advantages of gently pre-stressing the bone, amplifying haptic feedback, enhancing hydration, increasing plasticity, infusing bone fragments into the lattice structure, reducing heat build-up and improving hydrodynamic lubricity, as well as minimizing the sensation of trauma visited on a patient.

### BRIEF DESCRIPTION OF THE SEVERAL VIEWS OF THE DRAWINGS

These and other features and advantages of the present invention will become more readily appreciated when considered in connection with the following detailed description and appended drawings, wherein:

FIG. 1 depicts an exemplary application of the present invention at an edentulous (without teeth) jaw site that needs expansion to receive an implant;

FIG. 2 is a view as in FIG. 1, but showing the resulting fully prepared osteotomy as achieved through use of the present invention in a progressive series of expansion steps;

FIG. 3 is a view as in FIG. 1 showing a progressive expansion step with a rotary osteotome according to one embodiment of this invention;

FIG. 4 is a view as in FIG. 2 in which an installed implant is poised to receive an abutment or base for subsequent prosthetic (not shown);

FIG. 5 is a diagrammatic view illustrating by way of example the use of a surgical kit containing four osteotomes of progressively larger diameter according to the present invention in combination with a reversible drill motor to concurrently prepare three separate osteotomy sites in a human jaw using selective reversal of osteotome direction to enlarge each osteotomy either by cutting or densifying without removing the osteotome from the surgical drill motor;

FIG. 6 is a side elevation view of a rotary osteotome according to one embodiment of this invention;

FIG. 7 is a simplified cross-sectional view showing a surgical procedure referred to herein as “bounce” where an osteotome according to the present invention is repeatedly pushed into the osteotomy and withdrawn while the osteotome remains spinning in a repetitive manner so as to enlarge the osteotomy while enabling the surgeon to manage the expansion rate (and other factors) while making adjustments on-the-fly;

FIG. 8 is an exemplary graph plotting the force applied by a user to advance the body into an osteotomy against the depth of penetration into the osteotomy (or hole) in three separate procedures in order to illustrate that the surgeon (or user) can make on-the-fly adjustments to the advancing force depending on particular situation;

FIG. 9 is a simplified stress-strain curve generally representative of bone, metal foam and other host materials for with the present invention is suited for use;

FIG. 10 is an enlarged view of the apical end of a rotary osteotome according to one embodiment of this invention;

FIG. 11 depicts a cross-section through an osteotomy with a rotary osteotome disposed partially within as in the midst of an expansion procedure according to this invention;

FIG. 12 is an enlarged view of the area circumscribed at 12 in FIG. 11 and enhanced with reaction forces (R) as applied by the walls of the bone to the rotary osteotome in response to rotation of the osteotome in the non-cutting direction;

FIG. 13 is a diagram of the reaction forces (R) of FIG. 12, shown broken into component lateral (Rₓ) and axial (R_{y}) forces;

FIG. 14 is a fragmentary perspective view of the apical end of a rotary osteotome according to one embodiment of this invention;

FIG. 15 is an end view of the apical end of a rotary osteotome of FIGS. 6, 10 and 14;

FIG. 15A is a cross-section of the apical end of an osteotome according to this invention taken generally along the semi-circular lines 15A-15A in FIG. 15;

FIG. 16 is an enlarged view of a land as circumscribed at 16 in FIG. 15;

FIG. 17 is an exaggerated cross-section through an osteotomy with the apical end of a rotary osteotome shown at various stages of the expansion procedure in order to describe the zones of an osteotomy that experience grinding, compression and auto-grafting with each stage of the expansion process;

FIG. 18 is a cross-sectional view taken generally along lines 18-18 in FIG. 17;

FIG. 19 is a cross-sectional view taken generally along lines 19-19 in FIG. 17;

FIG. 20 is an enlarged view of the area circumscribed at 20 in FIG. 17 and depicting the bone grinding and auto-grafting features of the apical end;

FIG. 21 is a fragmentary perspective view of the apical end as in FIG. 14 but from a slightly different perspective and illustrating the region of the apical end where bone material collects and is subsequently repatriated into surrounding bone;

FIG. 22 is a micro-CT image developed during testing of a prototype rotary osteotome according to this invention, and showing a transverse slice through a Porcine03 medial tibial plateau with comparative holes created by: (A-left) a prior art burr drill, (B-center) the rotary osteotome of this invention rotated in a cutting direction, and (C-right) the rotary osteotome of this invention rotated in a non-cutting direction;

FIGS. 23A-D are micro-CT images developed during testing of a prototype rotary osteotome according to this invention, and showing comparative axial slice views of Porcine03 medial tibial plateau holes created with a prior art burr drill (FIG. 23A) and the rotary osteotome of this invention rotated in a non-cutting direction (FIG. 23C), and comparative axial slice views of average bone mineral density projection of 1 cm volume around Porcine02 medial holes created with a prior art burr drill (FIG. 23B) and the rotary osteotome of this invention rotated in a non-cutting direction (FIG. 23D);

FIG. 24 shows an alternative embodiment of the osteotome of this invention configured for high-frequency vibration rather than rotation;

FIG. 25 is a cross-section through an osteotomy with the alternative osteotome of FIG. 24 disposed partially completing an expansion procedure according to this invention;

FIG. 26 is an enlarged view of the apical end of the alternative osteotome of FIG. 24;

FIG. 27 is a simplified depiction of a human skeleton highlighting some examples of areas in which the novel osteotome of this invention might be effectively applied;

FIG. 27A is an enlarged view of a human vertebrae;

FIG. 27B is a view of the vertebrae as in FIG. 27A shown in cross-section with a rotary osteotome according to one embodiment of this invention disposed to enlarge an osteotomy for the purpose of receiving a fixation screw or other implant device; and

FIG. 28 is a perspective view of a foam metal product having a hole formed therein using a rotary osteotome according to this invention exemplifying at least one non-bone commercial application;

FIG. 29 is a cross-sectional view as in FIG. 7 showing osteotome slightly raised out of contact with the inner sidewall of the osteotomy with irrigating fluid being forcefully propelled in-between the flutes like a screw pump toward the bottom of the precursor hole, and depicting a generally uniform pressure gradient in the surrounding irrigating fluid by the use of radiating arrows;

FIG. 30 is an enlarged view of the area circumscribed at 30 in FIG. 29 showing the physical separation between the osteotome body and the inner sidewall of the osteotomy;

FIG. 31 is a view as in FIG. 29 but showing osteotome pressed down into contact with the inner sidewall of the osteotomy and the resulting changes in pressure applied to the inner sidewall of the osteotomy; and

FIG. 32 is a fragmentary cross-sectional view taken generally along lines 32-32 of FIG. 31 showing the elevated hydrodynamic pressure spike generated against the bone sidewall immediately prior to contact with a working edge.

### DETAILED DESCRIPTION OF THE INVENTION

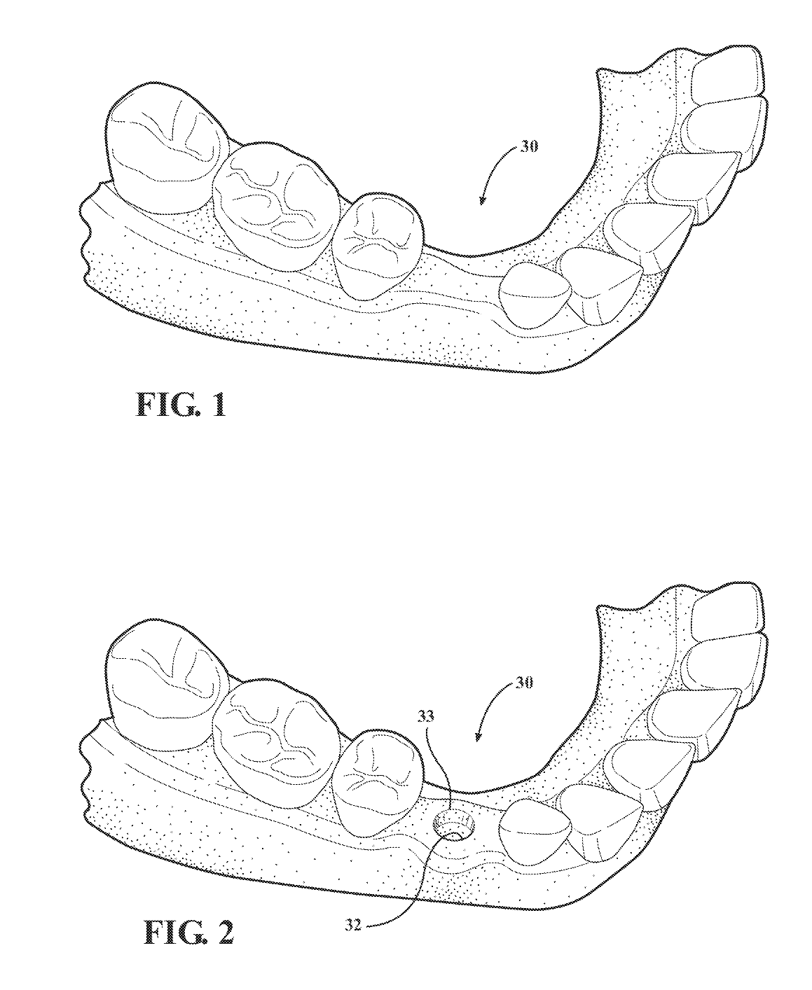

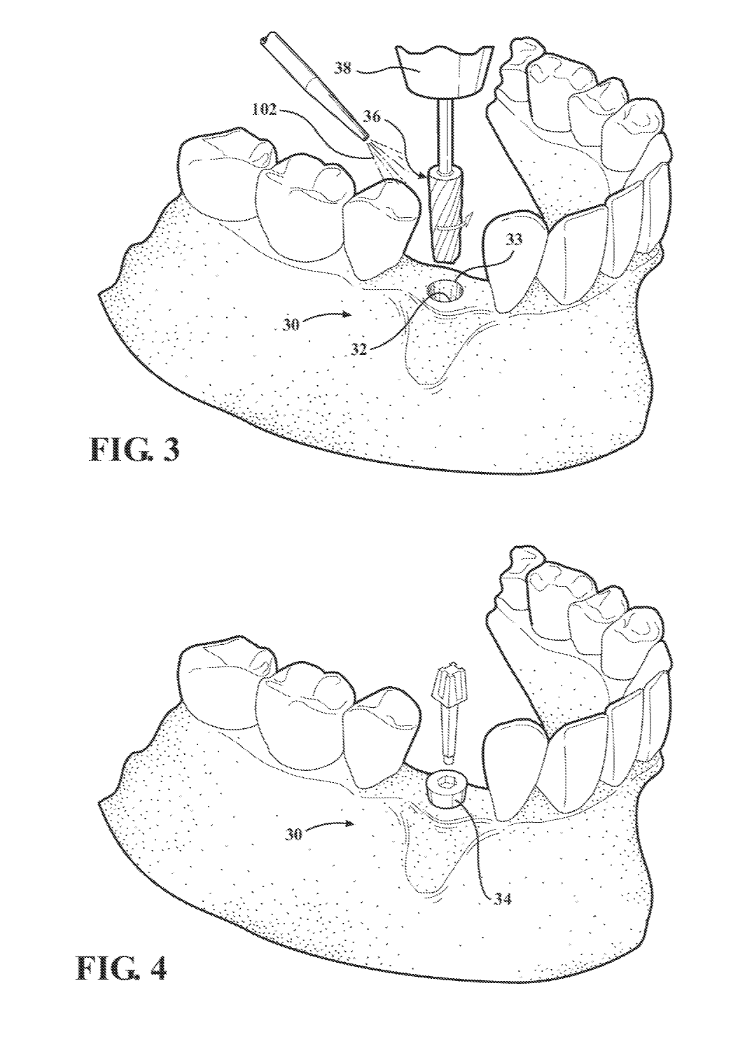

Referring to the figures, wherein like numerals indicate like or corresponding parts throughout the several views, FIGS. 1-4 show the example of a dental implant, in which preparation of an osteotomy is required to receive a bone implant (FIG. 4). It will be understood that this invention is not limited to dental applications, but may be applied across a wide spectrum of orthopedic applications. Furthermore, the invention is not even limited to bone applications, but may be used to prepare holes in other solid and cellular materials for industrial and commercial applications, to name but a few. In FIG. 1, an edentulous (without teeth) jaw site 30 is shown that needs expanded and prepared as an osteotomy 32 (FIG. 2) in order to receive an implant 34 (FIG. 4) or other fixture device. The series of steps include first boring a pilot hole into the recipient bone to form the initial osteotomy (not shown), then incrementally expanding the osteotomy using progressively wider rotary expander devices or osteotomes, generally indicated at 36, as shown in FIG. 3. Once the osteotomy has been prepared, the implant 34 or fixture screw is screwed into place as illustrated in FIG. 4. The procedure of forming an osteotomy is described, generally, in US 2013/0004918 published Jan. 3, 2013 to Huwais, the entire disclosure of which is hereby incorporated by reference in jurisdictions that recognize incorporation by reference.

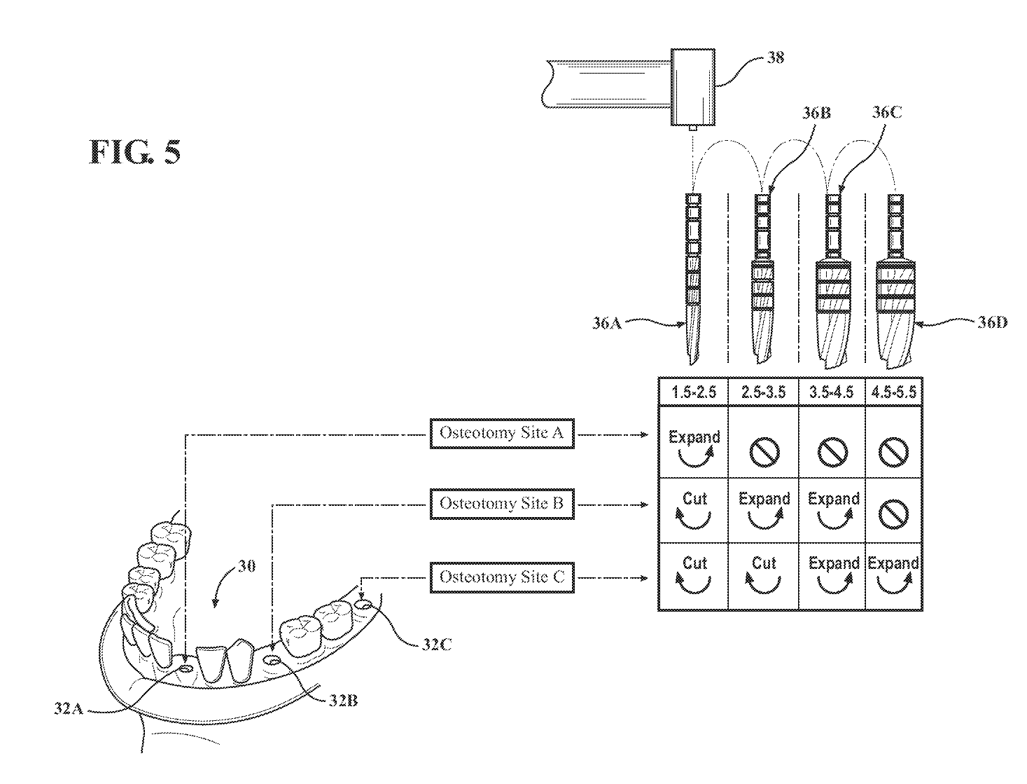

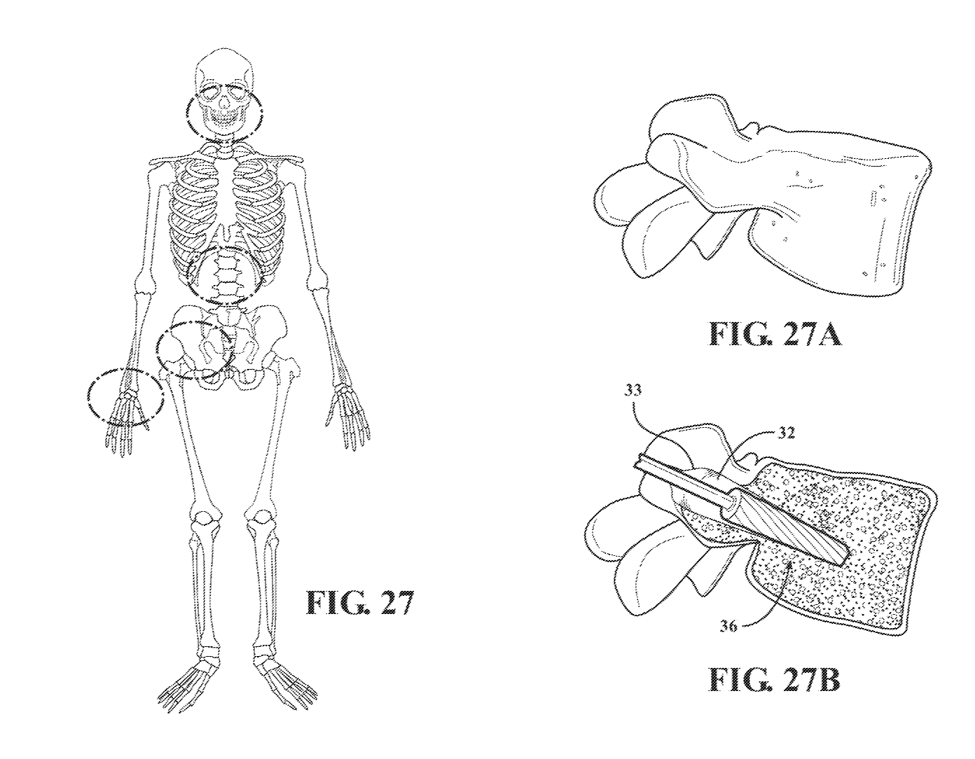

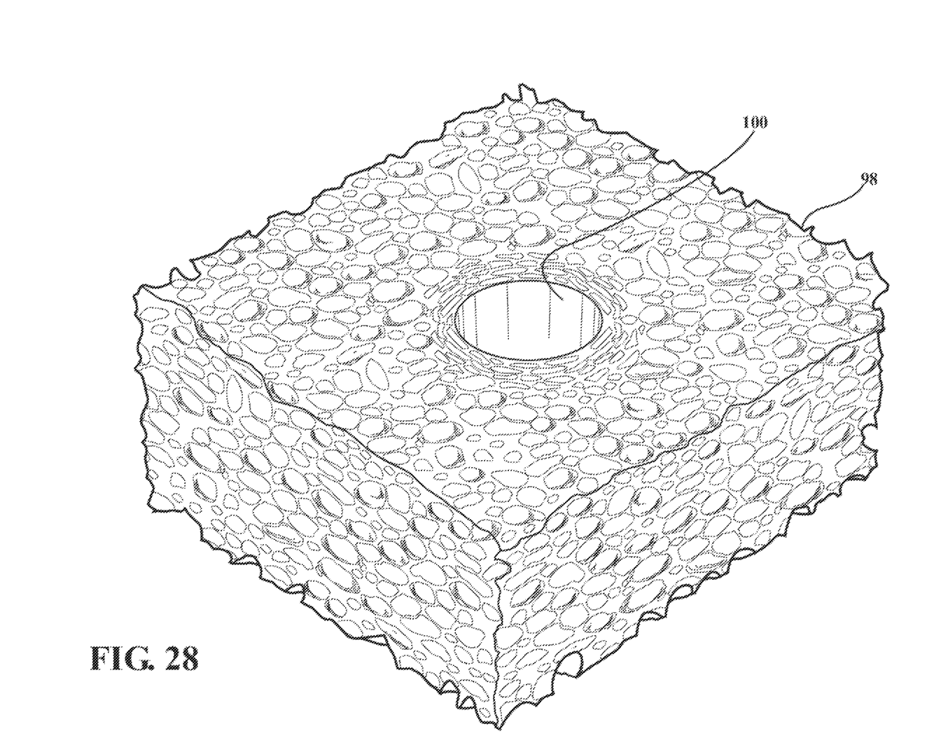

FIG. 5 is a diagrammatic view illustrating by way of example the use of a surgical kit containing four osteotomes 36A-D of progressively larger diameter according to the present invention in combination with a reversible surgical drill motor 38 to concurrently prepare three separate osteotomy sites 32A, 32B and 32C, respectively, in a human jaw bone 30 using selective reversal of osteotome direction to enlarge each osteotomy either by cutting or densifying without removing a given osteotome 36 from the surgical drill motor 38. Although the example is presented here again in the context of a dental application, those of skill in the art will appreciate that the described techniques are adaptable to non-dental applications including, but not limited to, joint replacement, bone fixations generally and foam metals (see for example FIGS. 27B and 28).

Returning to the example of FIG. 5, a first osteotomy site 32A is located in the front of the mandible bone 30 where the bone width is relatively narrow. The composition of the bone 30 in the region of the first osteotomy site 32A may be described as predominantly Type II. A second osteotomy site 32B is located slightly posterior of the first site 32A in a region of the mandible that has moderate bone 30 width. The composition of the bone 30 in the region of the second osteotomy site 32B may be described as generally a combination of Types II and III. A third osteotomy site 32C is located in a molar region of the mandible and is surrounded by a relatively generous bone 30 width. The composition of the bone 30 in the region of the third osteotomy site 32C may be described as predominantly Type III. Due to the varying width and composition of bone 30 at sites 32A, 32B and 32C, the surgeon does not wish to apply exactly the same technique and procedure to each osteotomy 32. By using the present invention, a surgeon (or user in non-surgical applications) has the ability to concurrently prepare all three osteotomy sites 32A-32C in different ways.

In this example, each osteotomy site 32A-32C is presumed to have a precursor osteotomy prepared by first drilling a pilot hole of 1.5 mm (Of course, the circumstances of any given surgical application, whether dental or non-dental in nature, will dictate the size of precursor hole and other characteristics of the operation.) The precursor hole that extends from an entrance 33 or mouth in the exposed surface of the bone (or in the flesh if not previously resected) to a bottom 35. The surgeon locks or otherwise installs the first osteotome 36A into the drill motor 38 and sets the rotational direction to counter-clockwise. Although the surgeon may vary the rotational speed of the osteotome 36 according to the dictates of the situation in their judgment, experimental results indicate that rotation speeds greater than about 200 RPM and torque settings between about 15-50 Ncm provide satisfactory results. More preferably rotation speeds between about 600-1500 RPM and torque settings between about 20-45 Ncm provide satisfactory results. And still more preferably, rotation speeds in the range of 800-1500 RPM and torque settings of about 35 Ncm provide satisfactory results.

The surgeon then pushes the rotating first osteotome 36A into the first osteotomy site 32A to expand through densifying (the details of which are described in detail below). However, due to the different compositional nature of the second 32B and third 32C osteotomy sites, the surgeon chooses to enlarge by cutting rather than densifying. To affect this, the surgeon reverses the rotational direction of the drill motor 38 to clockwise without removing the first osteotome 36A from the drill motor 38. Then, using a similar pushing motion, the surgeon enlarges the second 32B and third 32C osteotomy sites by removing bone material which may, if desired, be harvested.

At this stage in the hypothetical example, the first osteotomy site 32A has been expanded as much as the surgeon desires; no further expansion is needed of the first osteotomy site 32A. However, the second 32B and third 32C osteotomy sites both require additional expansion. The surgeon then installs the second osteotome 36B into the drill motor 38 and sets the rotational direction to counter-clockwise. Skipping the completed first osteotomy site 32A, the surgeon then expands the second osteotome 36B into the second osteotomy site 32B through densifying. The previously expanded holes in the second 32B and third 32C osteotomy sites are now considered precursor holes to the subsequent operations, each with an entrance 33 in the exposed surface of the bone and a closed bottom 35. Due to the different compositional nature of the third osteotomy site 32C, the surgeon chooses to enlarge by cutting rather than densifying. To affect this, the surgeon sets the rotational direction of the surgical motor 38 to clockwise without removing the second osteotome 36B from the surgical motor 38. Then, using a similar pushing motion, the surgeon enlarges the third osteotomy site 32C by removing bone material (which may, if desired, be harvested).

Once the remaining two osteotomy sites 32B, 32C have been enlarged by the second osteotome 36B, the surgeon locks or otherwise installs the third osteotome 36C into the drill motor 38 and sets the rotational direction to counter-clockwise. Again skipping the completed first osteotomy site 32A, the second 32B and third 32C osteotomy sites are enlarged by densifying. In both cases, the surgical motor 38 is set to turn in the counter-clockwise direction and the previously expanded holes are deemed precursor holes to the subsequent operations. The second osteotomy site 32B has now been expanded as much as the surgeon desires; no further expansion is needed of the second osteotomy site 32C. However, the third osteotomy site 32C still requires additional expansion. Therefore, the surgeon installs the fourth osteotome 36D into the drill motor 38 and sets the rotational direction to counter-clockwise. The enlargement accomplished by the third osteotome 36C now comprises a precursor hole for the next operation at the third osteotomy site 32C, with its newly enlarged entrance 33 in the exposed surface of the bone and a still closed bottom 35. Skipping the completed first 32A and second 32B osteotomy sites, the third 32C osteotomy site is enlarged by densifying using the previously described techniques. Implants 34 (or fixture portions of implants) can now be installed at each osteotomy site 32A-32C. The surgeon places a 3.0-3.25 mm implant (not shown) into the first osteotomy site 32A, a 5.0 mm implant (not shown) into the second osteotomy site 32B, and a 6.0 mm implant (not shown) in the third osteotomy site 32C. A surgeon may thus concurrently prepare a plurality of osteotomy sites 32A, 32B, 32C . . . 32n coupled with the ability to expand one site by densifying and another site by cutting without removing the osteotome 36 from the drill motor 38. The rotary osteotome 36 is thus configured to be turned at high speed in one direction to enlarge an osteotomy by densifying and in an opposite direction to enlarge an osteotomy by cutting.

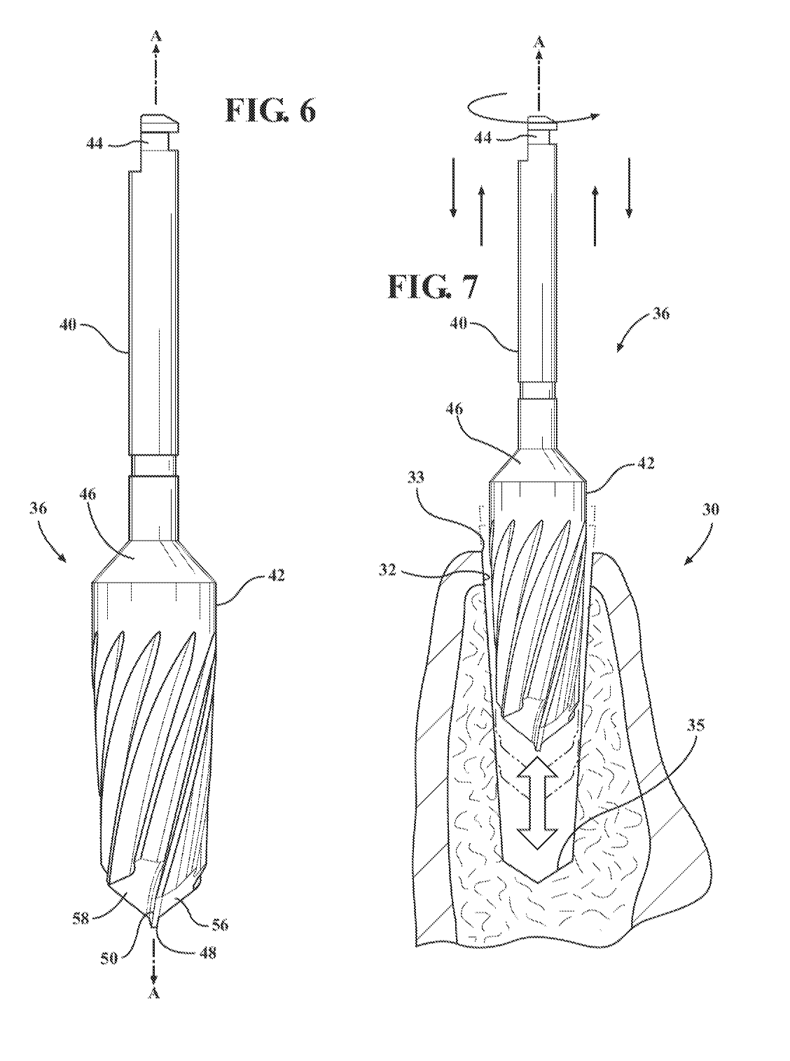

Turning now to FIG. 6, an osteotome 36 according to one preferred embodiment of this invention is shown including a shank 40 and a body 42. The shank 40 has an elongated cylindrical shaft that establishes a longitudinal axis of rotation A for the rotary osteotome 36. A drill motor engaging interface 44 is formed at the distal upper end of the shaft for connection to the drill motor 38. The particular configuration of the interface 44 may vary depending on the type of drill motor 38 used, and in some cases may even be merely a smooth portion of the shaft against which a 3- or 4-jaw collet may grip. The body 42 joins to the lower end of the shank 40, which joint may be formed with a tapered or domed transition 46. The transition 46 acts something like an umbrella as the surgeon irrigates with water during a procedure. The gentle transition 46 facilitates the flow of water (not shown) onto the osteotomy site with minimal splash or diversion, even while the osteotome 36 is spinning.

The body 42 has conically tapered profile decreasing from a maximum diameter adjacent the shank 40 to a minimum diameter adjacent an apical end 48. The apical end 48 is thus remote from the shank 40. The working length or effective length of the body is proportionally related to its taper angle and to the size and number of osteotomes (36A, 36B, 36C, 36D . . . 36n) in a kit. Preferably, all osteotomes 36 in a kit will have the same taper angle, and preferably the diameter at the upper end of the body 42 for one osteotome (e.g., 36A) is approximately equal to the diameter adjacent the apical end of the body 42 for the next larger size osteotome (e.g., 36B). Taper angles between about 1° and 5° (or more) are possible depending upon the application. More preferably taper angles between about 2°-3° will provide satisfactory results. And still more preferably, a taper angle of 2° 36′ is known to provide outstanding results for dental applications within the body 42 length typical requirements (e.g., ˜11-15 mm).

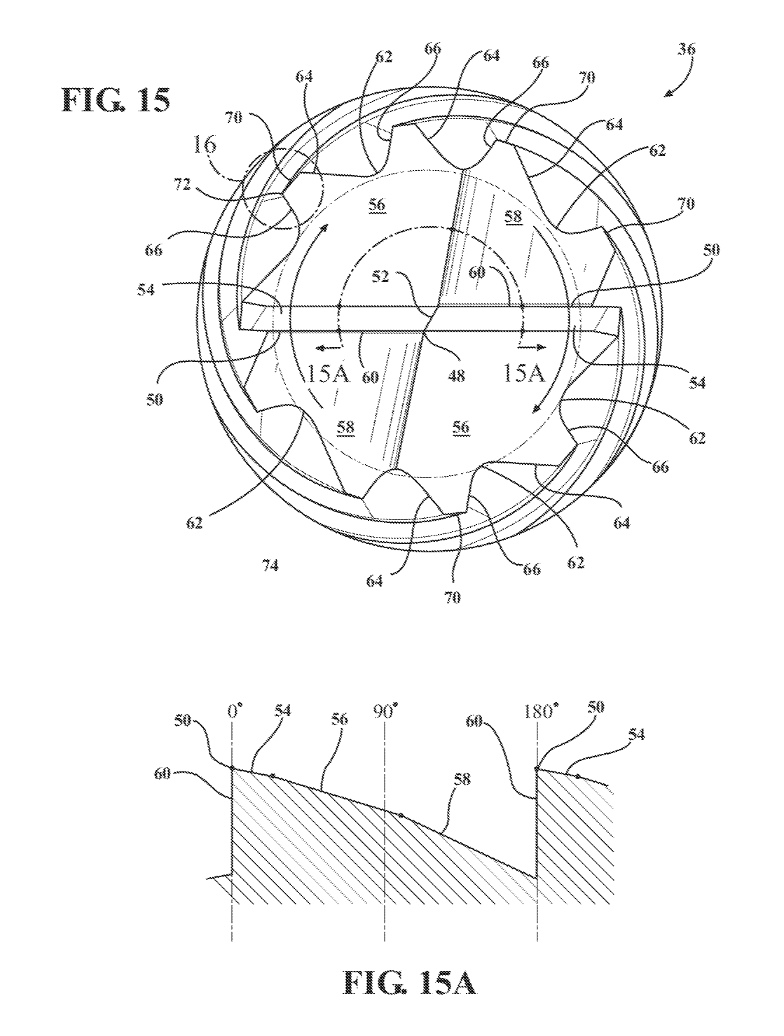

The apical end 48 is defined by at least one, but preferably a pair of lips 50. The lips 50 are in fact edges that are disposed on opposite sides of the apical end 48, but in the illustrated embodiment do not lie within a common plane. In other words, as shown in FIGS. 14 and 15, the lips 50 are slightly offset (in terms of a direct diametrical alignment) by the short length of a chisel point 52 extending central through the longitudinal axis A. The chisel point 52 is a common feature found in drilling tools, but alternative apical end 48 formations to the chisel point 52 are of course possible, including rounded and simple pointed shapes, etc. As mentioned, the lips 50 are edges that angle upwardly and outwardly (radially) from the apical end 48. The angle of the lips 50 may be varied to optimize performance of the particular application. In practice, the lip angle may be approximately 60° measured relative to longitudinal axis A, or 120° measured between the two opposing lips 50.

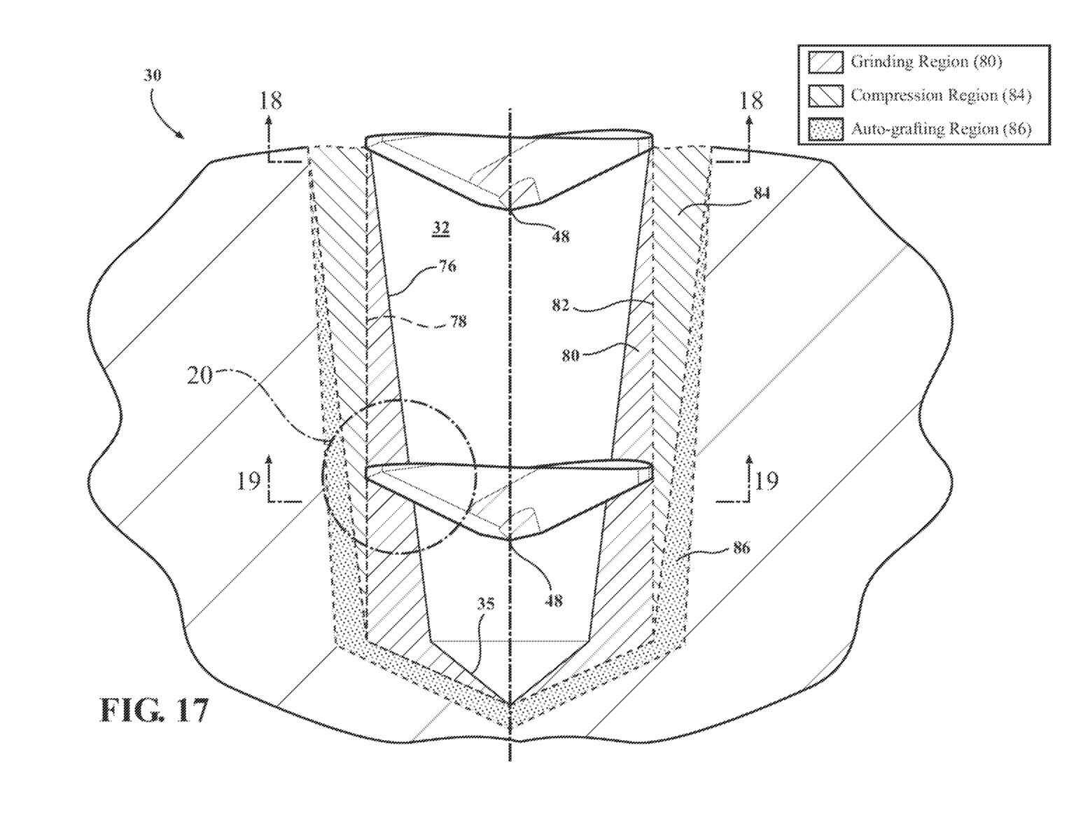

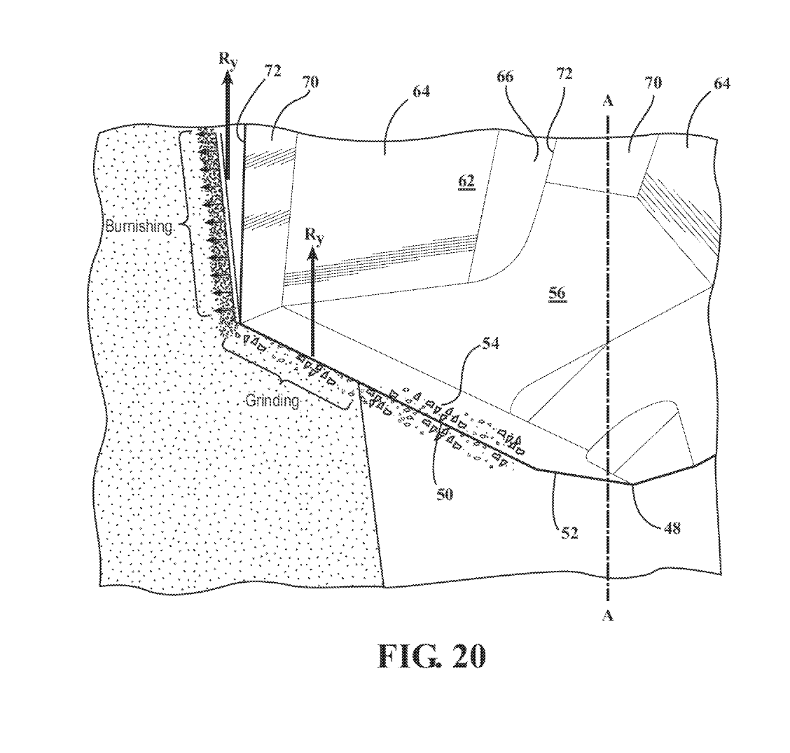

Each lip 50 has a generally planar first trailing flank 54. The first trailing flanks 54 are canted from their respective lips 50 at a first angle. The first angle may be varied to optimize performance and the particular application. In practice, the first angle may be approximately 45° measured relative to longitudinal axis A, or 90° measured between the two opposing first trailing flanks 54. It will be appreciated therefore that the two opposing first trailing flanks 54 are set in opposite directions so that when the osteotome 36 is rotated in use, the first trailing flanks 54 either lead or follow their respective lips 50. When first trailing flanks 54 lead their respective lips 50, the osteotome is said to be turning in a densifying or densifying or non-cutting direction; and conversely when the first trailing flanks 54 follow their respective lips 50, the osteotome is said to be turning in a cutting direction, i.e., with the lips 50 in the lead and serving to cut or slice bone. In the non-cutting direction, the first trailing flanks 54 form, in effect, a large negative rake angle for the lips 50 so as to minimize chip formation and shear deformation in the bone (or other host material) at the point of contact with the lips 50. (See for example FIGS. 17 and 20.)

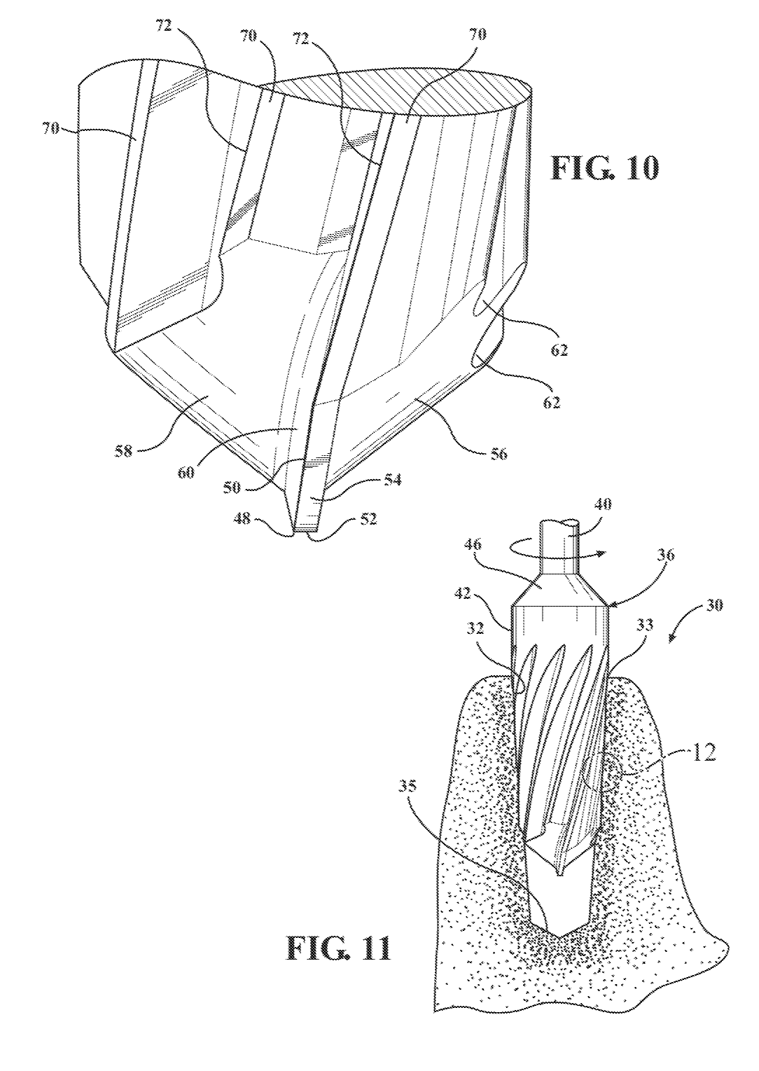

A generally planar second trailing flank 56 is formed adjacent and falls away from each first trailing flank 54 at a second angle that is smaller than the first angle. In an example where the first trailing flanks 54 are formed at 45° (relative to the axis A), the second trailing flanks 56 may be 40° or less. A generally planar relief pocket 58 is formed adjacent and falls away from each second trailing flank 56 at a third angle smaller than the second angle. In an example where the second trailing flanks 56 are formed at 40° (relative to the axis A), the relief pockets 58 (i.e., the third angle) may be 30° or less. Each relief pocket 58 is disposed in a sector of the apical end 48 between a second trailing flank 56 and a lip 50. A generally axially disposed lip face 60 extends between the relief pocket 58 and the adjacent lip 50. This is perhaps best shown in the enlarged view of FIG. 10. When the osteotome 36 is rotated in the cutting direction, a significant amount of bone chips collect in the relief pocket 58 region. When the osteotome 36 is rotated in the non-cutting direction, little to no bone chips collect in the relief pocket 58 region.

FIG. 15A is a highly simplified and exemplary semi-circular cross-section through the apical end 48 of the osteotome 36, as taken along lines 15A-15A in FIG. 15. In this simplified illustration, small points are placed at the intersection of planar surfaces. The points do not exist in reality, but are merely added in this view to help distinguish boundaries of the different surfaces (54, 56, 58, 60). In combination with the several other views and descriptions, FIG. 15A will help inform the skilled artisan as to the various facets (54, 56, 58, 60) and their relationships to one another and to the lips 50.

A plurality of grooves or flutes 62 are disposed about the body 42. The flutes 62 are preferably, but not necessarily, equally circumferentially arranged about the body 42. The diameter of the body 42 may influence the number of flutes 62. As an example, bodies 42 in the range of about 1.5-2.8 mm may be formed with three or four flutes; bodies 42 in the range of about 2.5-3.8 mm may be formed with five or six flutes; bodies 42 in the range of about 3.5-4.8 mm may be formed with seven or eight flutes; and bodies 42 in the range of about 4.5-5.8 mm may be formed with nine or ten flutes. Of course, number of flutes 62 may be varied more or less than the examples given here in order to optimize performance and/or to better suit the particular application.

In the illustrated embodiment, the flutes 62 are formed with a helical twist. If the cutting direction is in the right-hand (clockwise) direction, then preferably the helical spiral is also in the right hand direction. This RHS-RHC configuration is shown throughout the Figures, although it should be appreciated that a reversal of cutting direction and helical spiral direction (i.e., to LHS-LHC) could be made if desired with substantially equal results. The diameter of the body 42 may influence the angle of the helical spiral. As an example, bodies 42 in the range of about 1.5-2.8 mm may be formed with a 9.5° spiral; bodies 42 in the range of about 2.5-3.8 mm may be formed with an 11° spiral; bodies 42 in the range of about 3.5-4.8 mm may be formed with a 12° spiral; and bodies 42 in the range of about 4.5-5.8 mm may be formed with a 12.5° spiral. Of course, the spiral angles may be varied more or less than the examples given here in order to optimize performance and/or to better suit the particular application.

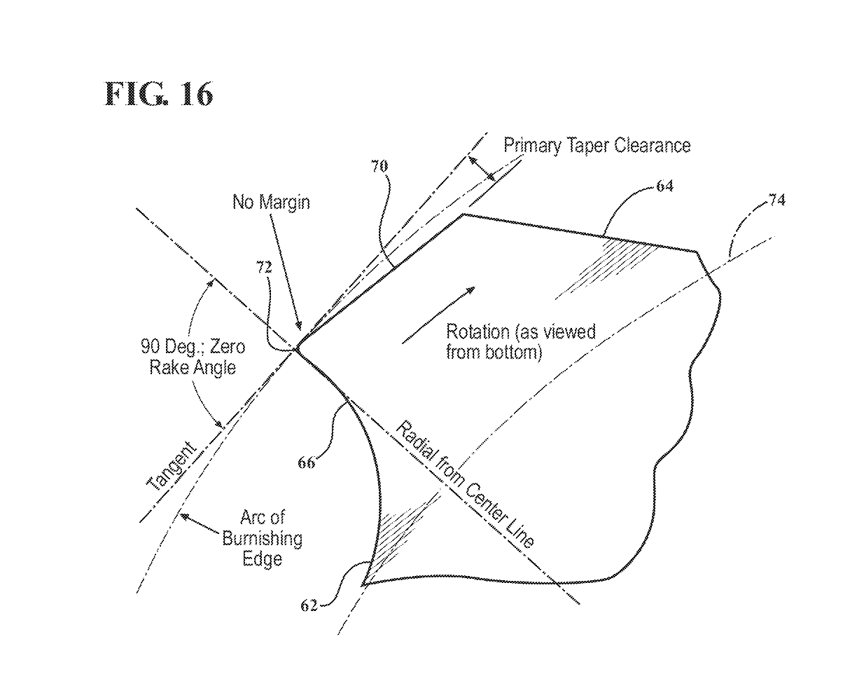

As perhaps best shown in FIGS. 15 and 16, each flute 62 has a densifying face 64 and an opposing cutting face 66. A rib or land is formed between adjacent flutes 62, in alternating fashion. Thus, a four-flute 62 osteotome 36 will have four lands, a ten-flute 62 osteotome 36 will have ten interleaved lands, and so forth. Each land has an outer land face 70 that extends between the densifying face 64 of the flute 62 on one side and the cutting face 66 of the flute 62 on its other side. The edge-like interface between each land face 70 and its associated cutting face 66 is referred to as a working edge 72. Depending on the rotational direction of the osteotome 36, the working edge 72 either functions to cut bone or densify bone. That is, when the osteotome is rotated in the cutting direction, the working edges 72 slice and excavate bone (or other host material). When the osteotome is rotated in the non-cutting direction, the working edges 72 compress and radially displace bone (or other host material) with little to no cutting whatsoever. This compression and radial displacement is exhibited as gentle pushing of the osseous structure laterally outwardly in a condensation mechanism. FIG. 15 depicts a web circle 74 superimposed as a broken circle. The web circle 74, or simply web 74, is the root or central portion of the body 42 that joins all of the lands. The diameter of the web circle 74 varies with the tapering diameter of the body 42.

In the preferred embodiment, the working edges 72 are substantially margin-less, in that the entire portion of each land face 70 is cut away behind the working edge 72 to provide complete clearance. In standard prior art burs and drills, margins are commonly incorporated behind the working edge to guide the drill in the hole and maintain the drill diameter. Primary taper clearance angles, i.e., the angle between a tangent of the working edge 72 and each land face 70 as shown in FIG. 16, may fall anywhere between about 1° and 30° depending upon the application. More preferably primary taper clearance angles will range between about 5°-20°. The diameter of the body 42 may influence the angle of the primary taper clearance. As an example, bodies 42 in the range of about 1.5-2.8 mm may have land faces 70 formed with a 15° primary taper clearance; bodies 42 in the range of about 2.5-3.8 mm may have land faces 70 formed with an 15° primary taper clearance; bodies 42 in the range of about 3.5-4.8 mm may have land faces 70 formed with a 12° primary taper clearance; and bodies 42 in the range of about 4.5-5.8 mm may have land faces 70 formed with a 10° primary taper clearance. Of course, the primary taper clearance angles may be varied more or less than the examples given here in order to optimize performance and/or to better suit the particular application. As mentioned above in connection with the angle of the helical twist, the substantially margin-less working edges 72 are shown, for example in FIG. 14, turning away from the non-cutting direction as the conically tapered profile of the body 42 decreases in diameter. In other words, when the non-cutting direction is counter-clockwise as shown in FIG. 14, the helical twist of the working edges 72 winds in the counter-clockwise direction when viewed from the top of the body 42 looking toward its apical end 48. Or conversely, as shown in FIG. 14 when viewed from the apical end 48 looking toward top of the body 42, the twist will appear to be in the clockwise direction. Thus, when the non-cutting direction is counter-clockwise, the working edges 72 will “turn away from the non-cutting direction” when all of the land faces 70 and flutes 62 orbit counter-clockwise about the longitudinal axis A as one traces each land face 70 and flute 62 downwardly toward the apical end 48.

The cutting face 66 establishes a rake angle for each respective working edge 72. A rake is an angle of slope measured from the leading face of the tool (the working edge 72 in this case) to an imaginary line extending perpendicular to the surface of the worked object (e.g., inner bone surface of the osteotomy). Rake angle is a parameter used in various cutting and machining processes, describing the angle of the cutting face relative to the work. Rake angles can be positive, negative or zero. The rake angle for working edge 72 when rotated in a cutting direction is preferably zero degrees (0°). In other words, the cutting face 66 is oriented approximately perpendicular to a tangent of the arc scribed through the working edge 72. As shown in FIG. 16, this establishes a crisp cutting edge 72 well-suited to cut/slice bone when the osteotome 36 is rotated in the cutting direction.

However, when the osteotome 36 is rotated in the non-cutting direction, the rake angle is established between the working edge 72 and the land face 70, which as previously stated may lie at a large negative rake angle in the order of 10°-15° (for example). The working edge 72 is fixed relative to the body 42 so that the negative rake angle is maintained while the tool 36 is rotated in a non-cutting direction. The large negative rake angle of the working edge 72 (when rotated in a non-cutting direction) applies outward pressure at the point of contact between the wall of the osteotomy 32 and the working edge 72 to create a compression wave ahead of the point of contact, loosely akin to spreading butter on toast.

The densifying of metal is a process that improves metal surface quality. Densifying is a well-controlled plastic deformation process in which force is applied to a surface by sliding hard smooth ball or roller. The mechanism of densifying occurs when the contact stress exceeds the yield strength of the material. Successful outcome of densifying is governed by several parameters, which are: densifying speed, densifying feed rate, number of passes, geometry and material of densifying tool as well as the densified surface, and the applied densifying force which dictate the densifying depth. In densifying process, surface irregularities are distributed without material loss, which close porosity, increases surface hardness, maintains dimensional stability, and improves fatigue strength by inducing residual compressive stress.

Downward pressure applied by the surgeon is needed to keep the working edge 72 in contact with the bone surface of the osteotomy being expanded, that is, to keep it pushing on the compression wave. This is aided by the taper effect of the osteotomy and tool 36 to create lateral pressure (i.e., in the intended direction of expansion). The harder the surgeon pushes down, the more pressure is exerted laterally. This gives the surgeon complete control of the expansion rate irrespective to a large degree on the rotation speed of the osteotome 36. Thus, the densifying effect's intensity depends on the amount of force exerted on the osteotome 36. The more force exerted, the quicker expansion will occur.

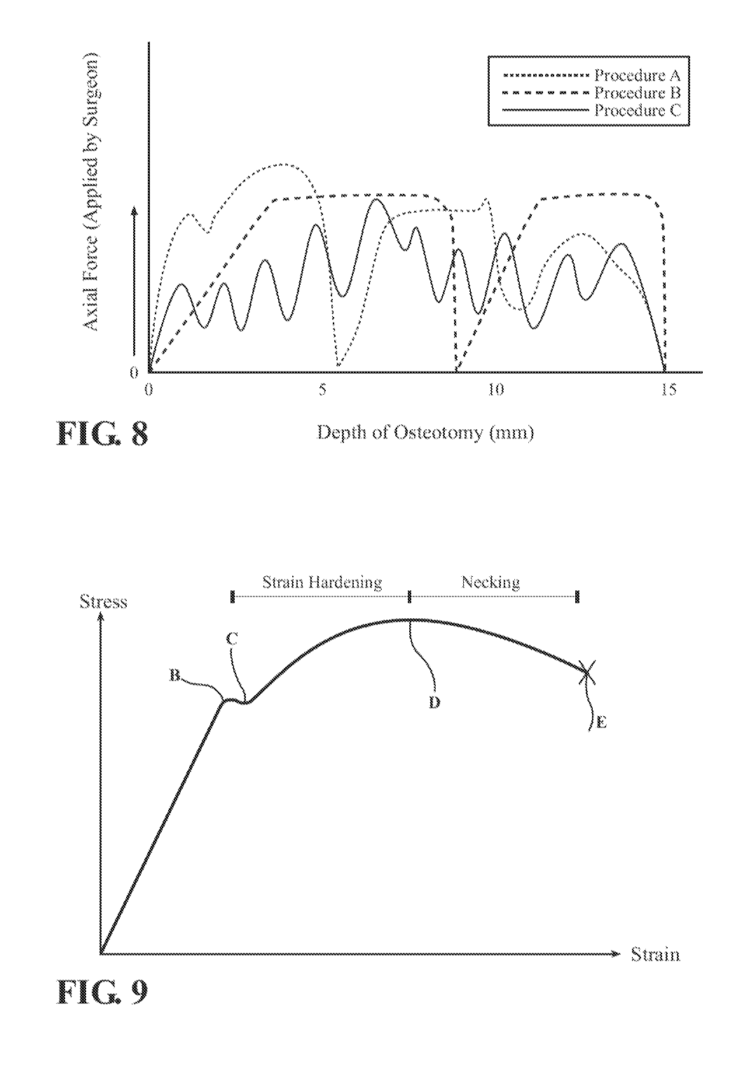

As the working edge 72 drags across the bone, the force on the working edge 72 can be decomposed into two component forces: one normal to the bone's surface, pressing it outwardly, and the other tangential, dragging it along the inner surface of the osteotomy. As the tangential component is increased, the working edge 72 will start to slide along the bone. At the same time, the normal force will deform the softer bone material. If the normal force is low, the working edge 72 will rub against the bone but not permanently alter its surface. The rubbing action will create friction and heat, but this can be controlled by the surgeon by altering, on-the-fly, the rotation speed and/or pressure and/or irrigation flow. Because the body 42 of the osteotome 36 is tapered, the surgeon may at any instant during the surgical procedure lift the working edges 72 away from contact with the surface of the bone to allow air cooling and/or irrigation. This can be done in a controlled “bouncing” fashion where pressure is applied in short bursts with the surgeon continuously monitoring progress and making fine corrections and adjustments. See FIGS. 7 and 8 which illustrate this variable application of force and the ability for the osteotome to be lifted out of engagement—at any time during a procedure—with the walls of the osteotomy 32. As the surgeon-applied downward force increases, eventually the stresses in the bone's surface exceed its yield strength. When this happens, the working edge 72 will plow through the surface and create a trough behind it. The plowing action of the working edge 72 thus progressively enlarges the osteotomy.

FIG. 9 depicts a Stress-Strain curve that is generally illustrative for bone and other ductile materials including but not limited to foam metals of the type used in various commercial, industrial and aerospace applications. The straight-line segment of the curve from the point of origin (0,0) to B represents the material's elastic response region. Reference point B indicates the elastic limit of the material. While the elastic properties of bone are well-known, if the load imposed by the surgeon does not exceed the bone's ability to deform elastically, i.e., beyond point B, the bone will promptly return to its initial (un-deformed) condition once the stress is removed. On the other hand, if the load imposed by the surgeon exceeds the bone's ability to deform elastically, the bone will deform and change shape permanently by plastic deformation. In bone, the permanent change in shape is believed to be associated with micro-cracks that allow energy release, a compromise that is a natural defense against complete fracture. If these micro-cracks are small, the bone remains in one piece while the osteotomy expands. The region of plastic deformation extends from the yield point of the material (C), all the way to the point of fracture (E). The peak (D) of the curve between yield point (C) and fracture (E) indicates the material's ultimate tensile strength. When a material (e.g., bone or foam metal) is subjected to stress in the region between its yield point (C) and its ultimate tensile strength (D), the material experiences strain hardening. Strain hardening, also known as work hardening or cold working, is the strengthening of a ductile material by plastic deformation. This strengthening occurs because of dislocation movements and dislocation generation within the crystal structure of the material—which for bone materials corresponds with the above-mentioned micro-cracks. The material tends to experience necking when subjected to stress in the region between its ultimate tensile strength (D) and the point of fracture (E).

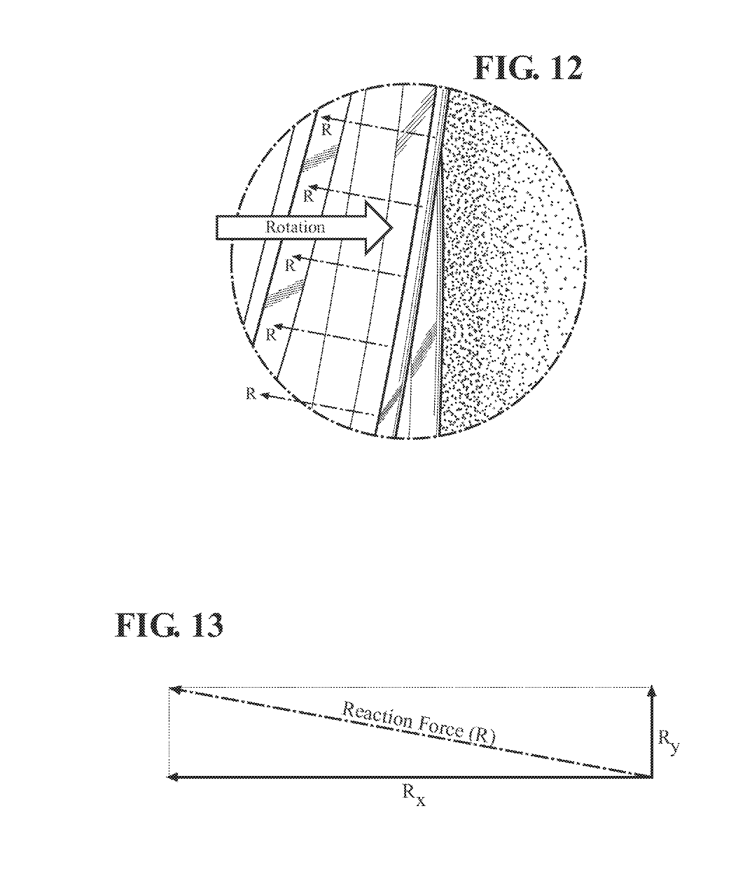

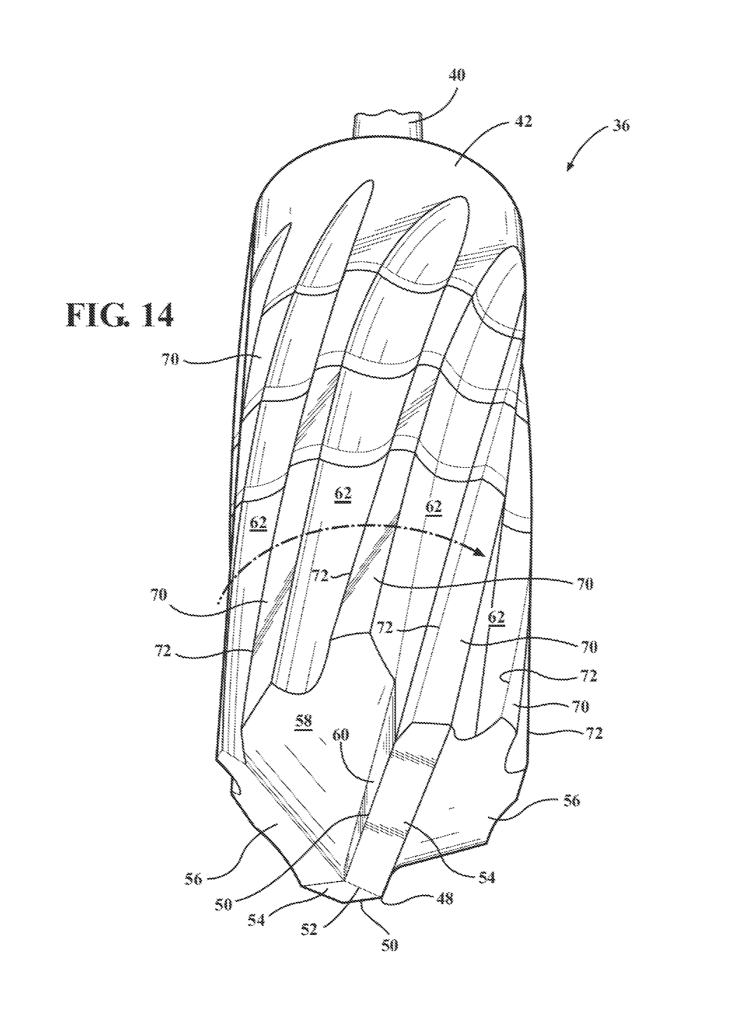

The direction of helical twist can be designed so as to play a role in contributing to the surgeon's control so that an optimum level of stress can be applied to the bone (or other host material) throughout the expansion procedure. In particular, the RHS-RHC configuration described above, which represents a right-hand spiral for a right-hand cutting direction (or alternatively an LHS-LHC configuration, not shown) applies a beneficial opposing axial reaction force (R_{y}) when the osteotome 36 is continuously rotated at high speed in a non-cutting direction and concurrently forcibly advanced (manually by the surgeon) into an osteotomy 32. This opposing axial reaction force (R_{y}) is illustrated graphically in FIGS. 11-13 as being directionally opposite to the forcibly advanced direction into the osteotomy 32. In other words, if the surgeon operating the osteotome 36 is pushing the osteotome 36 downwardly into an osteotomy 32, then the opposing axial reaction force (R_{y}) works in the opposite direction to push the osteotome upwardly. The opposing axial reaction force (R_{y}) is the vertical (or perhaps more accurately the “axial” vis-à-vis the longitudinal axis A) component of the reaction force (R) that is the Newtonian “equal and opposite reaction force” applied by the bone against the full length of the working edges 72 of the osteotome 36 (i.e., Newton's Third Law of Motion). An opposing axial reaction force (R_{y}) is also created by the effective a large negative rake angle at the lips 50 when the osteotome 36 is rotated in a non-cutting direction, as shown in FIG. 20 and easily perceived from FIG. 15A. Those of skill in the art will appreciate alternative embodiments in which the opposing axial reaction force (R_{y}) is created by either the configuration of the lips 50 alone or of the working edges 72 alone rather than by both (50, 72) acting in concert as in the preferred embodiment.

In order for a surgeon to advance the apical end 48 toward the bottom of the osteotomy 32 when the osteotome 36 is spinning in the non-cutting direction, he or she must push against and overcome the opposing axial reaction forces (R_{y}) in addition to supplying the force needed to plastically displace/expand the bone as described above. The osteotome 36 is designed so that the surgeon must continually work, as it were, against the opposing axial reaction forces (R_{y}) to expand an osteotomy by densifying. Rather than being a detriment, the opposing axial reaction forces (R_{y}) are a benefit to the surgeon by giving them greater control over the expansion process. Because of the opposing axial reaction forces (R_{y}), the osteotome 36 will not be pulled deeper into the osteotomy 32 as might occur with a standard “up cutting” twist drill or burr that is designed to generate a tractive force that tends to advance the osteotome towards the interior of the osseous site; such up-cutting burrs have the potential to grab and pull the burr more deeply into the osteotomy, such that a surgeon could unexpectedly find themselves pulling up on a spinning burr to prevent over-penetration.

The intensity of the opposing axial reaction forces (R_{y}) is always proportional to the intensity of force applied by the surgeon in advancing the body 42 into the osteotomy 32. This opposing force thus creates real-time haptic feedback that is intuitive and natural to inform the surgeon whether more or less applied force is needed at any given instant. This concurrent tactile feedback takes full advantage of the surgeon's delicate sense of touch by applying reaction forces (R, and in particular the axial component R_{y}) directly through the osteotome 36. The mechanical stimulation of the opposing axial reaction forces (R_{y}) assists the surgeon to better control the expansion procedure on the basis of how the bone (or other host material) is reacting to the expansion procedure in real time.

Thus, the controlled “bouncing” described above in connection with FIGS. 7-9 is made more effective and substantially more controllable by the opposing axial reaction forces (R_{y}) so that the surgeon can instinctively monitor progress and make fine corrections and applied pressure adjustments on-the-fly without losing control over the rate of expansion. The tactile feedback from the opposing axial reaction forces (R_{y}) allows a surgeon to intuitively exert stress on the bone material so that its strain response preferably resides in the strain hardening zone, that is, between its yield point (C) to its ultimate tensile strength (D). In any event, the surgeon will endeavor to maintain the stress (as generated by the force he or she applies through the rotating osteotome 36) above the elastic limit (B) and below the point of fracture (E). Of course, until passing the applied stress passes the elastic limit (B), the bone will not permanently deform at all; and to apply stress beyond the point of fracture (E) will cause the bone (or other host material) to break—possibly catastrophically.

The exemplary graph in FIG. 8 plots the force applied by a surgeon to advance the body 42 into an osteotomy 32 against its depth of penetration into the osteotomy 32 in three separate procedures (A-B-C) to graphically show how the surgeon can make these on-the-fly adjustments depending on particular situation they encounter. The applied force is, as mentioned above, the force manually generated by the surgeon and needed to overcome the combined opposing axial reaction forces (R_{y}) plus the forces needed to expand/deform the bone. The applied force creates stress in the bone (or other host material), so that it develops a strain response like that shown in FIG. 9. During an operation, the surgeon uses his or her skill to manually vary the applied stress so that the strain response remains within the plastic deformation region (B-E), and more preferably still within the more ideal strain hardening region (C-D). The configuration of the osteotome 36 in this embodiment, therefore, is designed to give a surgeon more control during an expansion (by densifying) procedure by generating proportional, opposing axial reaction forces (R_{y}) when the osteotome 36 continuously rotated and concurrently forcibly advanced into an osteotomy 32.

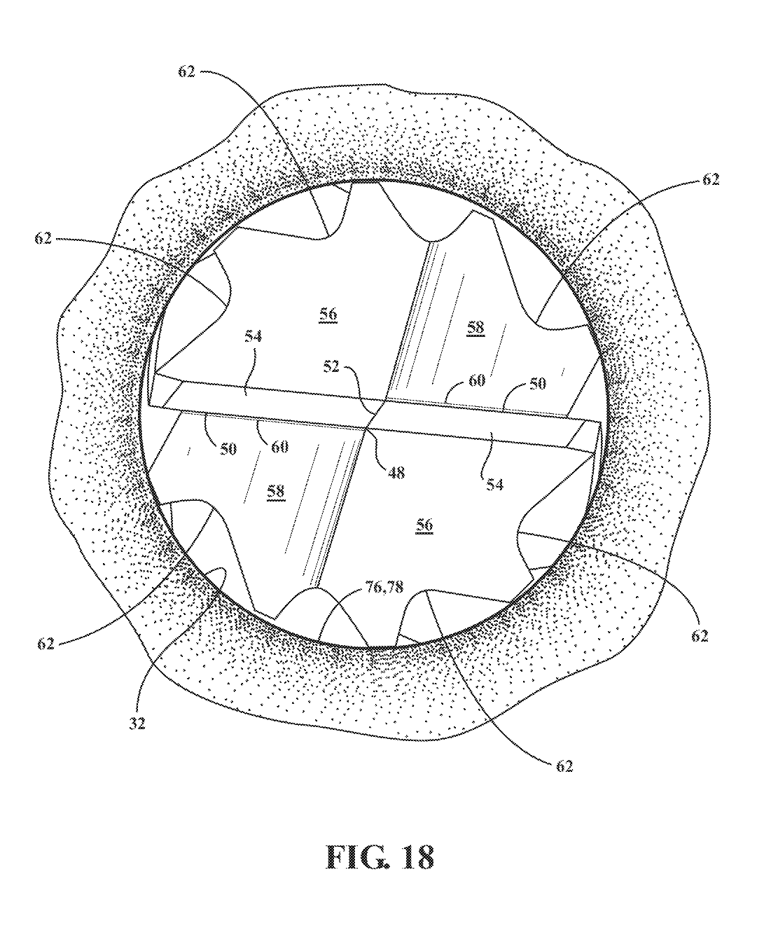

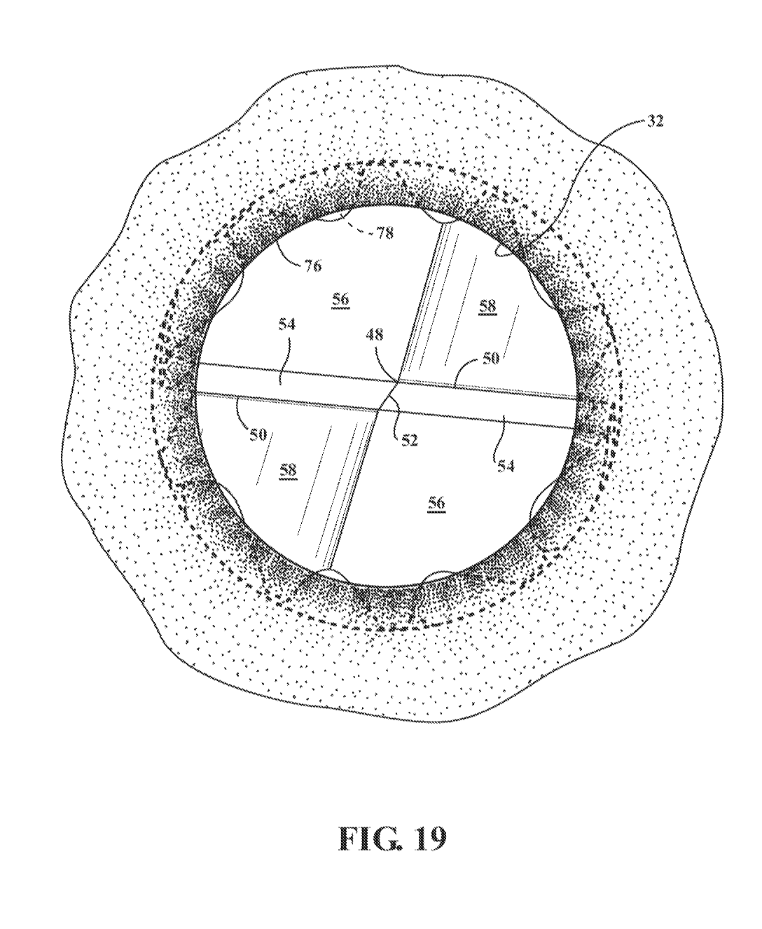

Turning now to FIGS. 17-21, another novel aspect of the present invention is illustrated—namely the ability of the rotary osteotome 36 to simultaneously auto-graft and compact bone when the osteotome 36 is continuously rotated at high speed in a non-cutting direction and concurrently forcibly advanced into an osteotomy 32. The compaction aspect may be defined as the gentle push of osseous structure laterally outwardly so as to condense the cells throughout the region surrounding the osteotomy 32. In FIG. 17, an osteotomy 32 formed by the present invention is shown with exaggerated taper on the order of ˜7° (as compared with the preferred taper angle in the range of about 2°-3°) in order to highlight the necessary grinding of a small amount of bone (or other host material) with each progressively larger osteotome 36.

In FIG. 17, surface 76 indicates the inner wall of the osteotomy 32 as prepared in a preceding expansion operation by an osteotome 36 of smaller size. That is to say, in this example the surface 76 represents a precursor hole. The apical end 48 of the next incrementally larger size osteotome 36 is shown in solid about to enter the osteotomy and again in phantom approximately ⅔ into the osteotomy 32. It is to be understood that the osteotome 36 is continuously rotated at high speed in a non-cutting direction (e.g., counter-clockwise in the preceding examples) and concurrently forcibly advanced into an osteotomy 32 by the surgeon's manual efforts. Construction line 78 indicates the cylindrical (i.e., non-tapering) path of the apical end 48 as it moves from top to bottom within the osteotomy 32. In other words, the diameter of the apical end 48 remains the same, and therefore the diameter of its path also remains constant over the distance it travels. When the osteotome 36 first enters the osteotomy 32 as shown in solid, the internal diameter of the prior osteotomy 76 is approximately equal to the diameter of the apical end 48. However the internal diameter of the prior osteotomy 76 progressively narrows (i.e., tapers inwardly) toward the bottom of the osteotomy. Yet as shown the cylindrical path of the apical end 48 remains constant. Therefore, as the osteotome 36 is advanced deeper toward the bottom of the osteotomy 32, more and more bone is ground away and/or displaced to make room for the advancing (larger) osteotome 36. Region 80, defined as the annular space between surfaces 76 and 78 (plus a portion of the apical end 48), represents the bone material that is milled by the outermost edges of the lips 50 as the apical end 48 makes its way to the full depth of the osteotomy 32. The milled or ground region 80 includes not only the side walls, but also the bottom end of the osteotomy 32. In a subsequent operation (not shown), when another osteotome 36 of the next larger size is used to further expand the osteotomy 32, a similar (but larger) region 80 will exist as its apical end is pushed to the bottom of the osteotomy 32, and so on.

Remaining within the context of FIG. 17, surface 82 indicates the outer wall of the osteotomy 32 as prepared by the expansion operation of osteotome 36 whose apical end 48 is illustrated in solid and phantom. The surface 82 is a substantially perfect negative of the revolving osteotome body 42. In other words, the surface 82 will have a taper equal to that of the osteotome body 42, and a bottom impression made by the spinning apical end 48 of the osteotome illustrated. Region 84, defined as the annular space between surfaces 78 and 82, represents the bone material that is plastically displaced by the working edges 72 of the lands as the osteotome body 42 makes its way to the full depth of the osteotomy 32. All of the bone material within region 84 is compressed radially outwardly into the surrounding bone structure without cutting, and therefore represents a zone of densified bone.

An important observation may be stated as: “What happens to the ground/milled bone material that once occupied region 80?”. As alluded to previously, the osteotome 36 is configured to simultaneously auto-graft and compact the ground/milled bone from region 80 as it is rotated and forcibly advanced into the osteotomy 32. The auto-grafting phenomena supplements the basic bone compression and condensation effects described above to further densify the inner walls 82 of the osteotomy. Furthermore, auto-grafting—which is the process of repatriating the patient's own bone material—enhances natural healing properties in the human body to accelerate recovery and improve osseointegration.

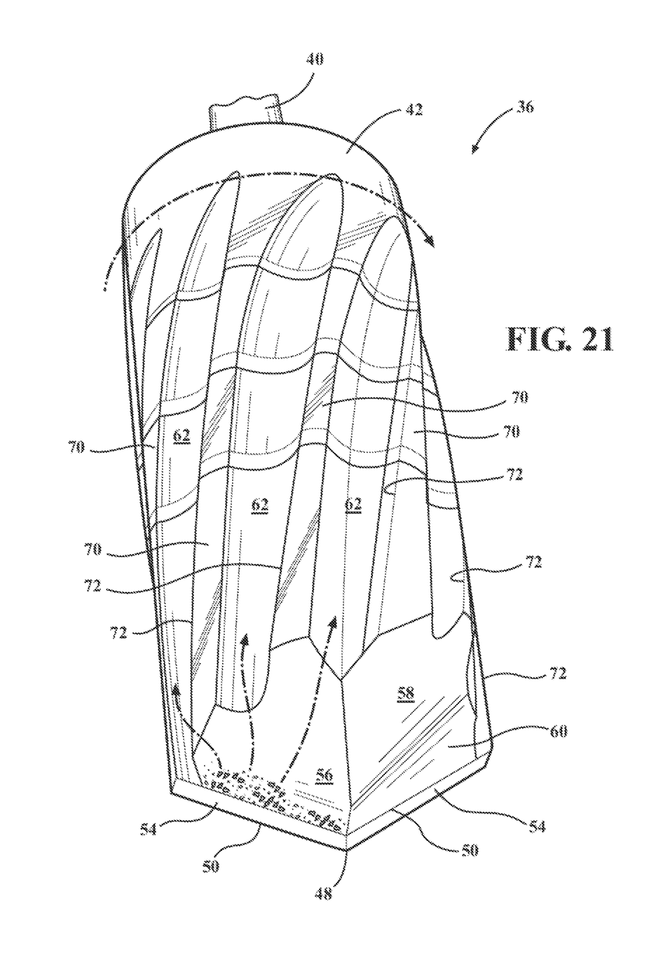

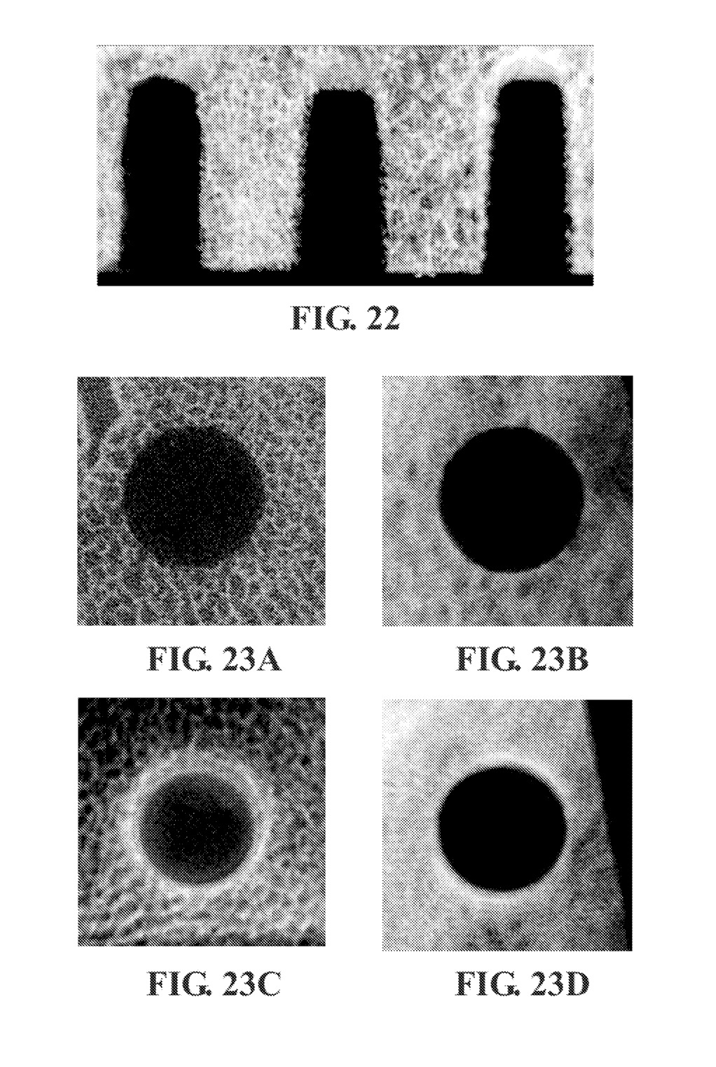

Turning to FIG. 20, an enlarged view is shown of the interface between the apical end 48 and the host bone material. At the point where the outermost edge of each rotating and forcibly advancing lip 50 contacts the bone, attrition causes the bone to be ground away. The bone debris collects mainly on the second trailing flanks 56, i.e., immediately behind the respective first trailing flanks 54. Some of the accumulated bone debris migrates radially inwardly along the lips 50 and is carried all the way to the very bottom of the osteotomy 32. The remainder of the accumulated bone debris is distributed along the flutes 62 which directly intersect the second trailing flanks 56 by the pressure exerted through the surgeon's manual pushing efforts. This is illustrated in FIG. 21. It is possible that a small fraction of bone debris could spill over into the relief pockets 58, but this is of minimal significance. Bone debris that is distributed up the flutes 62 works its way toward the associated land faces 70 where it is wiped and pressed into the cellular walls of the osteotomy 32—i.e. where it is grafted back into the patient's bone very near to the sight were it was harvested. Bone debris that is carried to the bottom of the osteotomy 32 is wiped and pressed into the bottom of the osteotomy 32. As a result, an auto-grafting zone 86 is developed around and under the compaction region 84, as shown in FIG. 17. Interestingly, the auto-grafting zone 86 is thinnest where the compaction zone 84 is thickest, and conversely the auto-grafting zone 86 is thickest where the compaction zone 84 is thinnest. And at the osteotomy bottom where this is little-to-no compaction at all, there is a significant zone of auto-grafting 86 which serves to densify (and positively stimulate) an area of the osteotomy 32 which could otherwise not be densified. It can therefore be appreciated that the auto-grafting phenomena is an ideal complement to the basic bone compression and condensation effects in preparing an osteotomy 32 to receive an implant 34 or other fixation device.

To summarize, the present invention describes a method for enlarging an osteotomy 32 by densifying (and/or by cutting when rotation is reversed) in preparation for a subsequently placed implant or fixture. The basic steps of the method begin with the provision of a host material, which in the preferred embodiment is bone however in other contemplated applications could either a cellular or non-cellular non-bone materials. A precursor hole 32 is also provided in the host material. The could either be a pilot hole drilled with a standard twist drill or a hole formed by previous application of the densifying techniques of this invention. In either case, the precursor hole 32 has an interior surface (i.e., sidewall) that extends between a generally circular entrance 33 in an exposed surface of the host material and a bottom 35 that is closed, most commonly by the host material. The bottom 35 will have a generally conical shape as created by the tip of the pilot drill or preceding osteotome 36. If the precursor hole is formed by a previous application of the densifying techniques of this invention, then its interior surface will be tapered with a frusto-conical shape that extending between the entrance 33 and the bottom 35, and with the entrance 33 having a larger diameter than the bottom 35.

The method further includes the step of providing a rotary osteotome 36 configured to be turned at high speed in one continuous non-reversing direction. To be clear, the osteotome 36 can be continuously rotated in one continuous non-reversing non-cutting direction to enlarge an osteotomy by densifying, or alternatively continuously rotated in an opposite continuous non-reversing direction to enlarge an osteotomy by cutting. The point intended to be made is that whether the osteotome 36 is enlarging by densifying or by cutting, it rotates without stopping in a given direction as opposed to oscillating/rocking motions as taught by some prior art systems. The osteotome 36 comprises a shank 40 and a body 42 joined to the shank 40. The body 42 has an apical end 48 remote from the shank 40, and a conically tapered profile that decreases from a maximum diameter adjacent the shank 40 to a minimum diameter adjacent the apical end 48.

The osteotome 36 is operatively connected to a surgical motor 38, with its rotation speed set somewhere between about 200-1500 RPM and its torque setting at about 15-50 Ncm. During the procedure, copiously irrigation is provided in the form of a continuous stream of a substantially incompressible liquid 102 onto the rotating body 42 adjacent the entrance 33 to the precursor hole 32.

The body 42 is continuously rotated in a non-cutting direction while its apical tip 48 is forcibly advanced (by the manual efforts of the surgeon) into the entrance 33 of the precursor hole 32. Continued advance results in an enlargement of the precursor hole 32 by forcibly pushing the rotating body 42 so that its working edges 72 sweep against the interior surface of the precursor hole 32 to gently expand the bone by incremental plastic deformations that cause a progressive enlargement of the precursor hole 32 beginning adjacent the entrance 33 and developing in a frustoconical pattern downwardly toward the bottom 35. This enlarging step preferably includes axially stroking the rotating body 42 within the precursor hole 32 so that the working edges 72 alternately lap against the bone interior surface with downward motion and then separate from the interior surface with upward motion in ever deepening movements that cause a progressive plastic deformation of the interior surface of the precursor hole. When the working edges 72 are in physical contact with the bone, the surgeon can manually apply variable axial pressure depending on the haptic sensed responsiveness of the bone. The enlarging step also includes lapping the working edges 72 against the interior surface of the precursor hole 32 without cutting into the surrounding bone, and in a manner where the rate of advance toward the bottom 35 of the precursor hole 32 is independent of the rate of rotation of the body 42. This latter characteristic is in contrast to some prior art systems that couple tool rotation with the rate of advance.

Notable improvements in this present invention include: grinding a progressively larger amount of bone material with the apical end 48 as the body 42 is advanced deeper into the osteotomy 32, auto-grafting the ground bone material into the host bone within the osteotomy 32 and compacting the ground bone material into the host bone with the fluted body 42, and also generating an opposing axial reaction force (R_{y}) in opposition to the advancing direction of the body 42 into the osteotomy 32. The opposing axial reaction force (R_{y}) is created by the configuration of the lips 50 and/or the working edges 72.

After removing the osteotome 36 from the expanded hole, additional expansion steps can be practiced to make the hole even larger, or the fixture portion of an implant or other anchoring device can be inserted into the expanded hole. The step of installing a fixture or anchor would include directly engaging an exterior anchoring thread form of the fixture or anchor into the expanded hole that has been formed by a working edge 72.

The tools and techniques of this invention are readily adaptable to the methods of computer generated implant placement guides, like those described for example in U.S. Pat. No. 6,814,575 to Poirier, issued Nov. 9, 2004 (the entire disclosure of which is hereby incorporated by reference in jurisdictions permitting incorporation by reference). According to these methods, a computer model is created giving jawbone 30 structural details, gum surface shape information and proposed teeth or dental prosthesis shape information. The computer model shows the bone structure, gum surface and teeth images properly referenced to one another so that osteotomy 32 positions can be selected taking into consideration proper positioning within the bone 30 as well as proper positioning with respect to the implant 34.

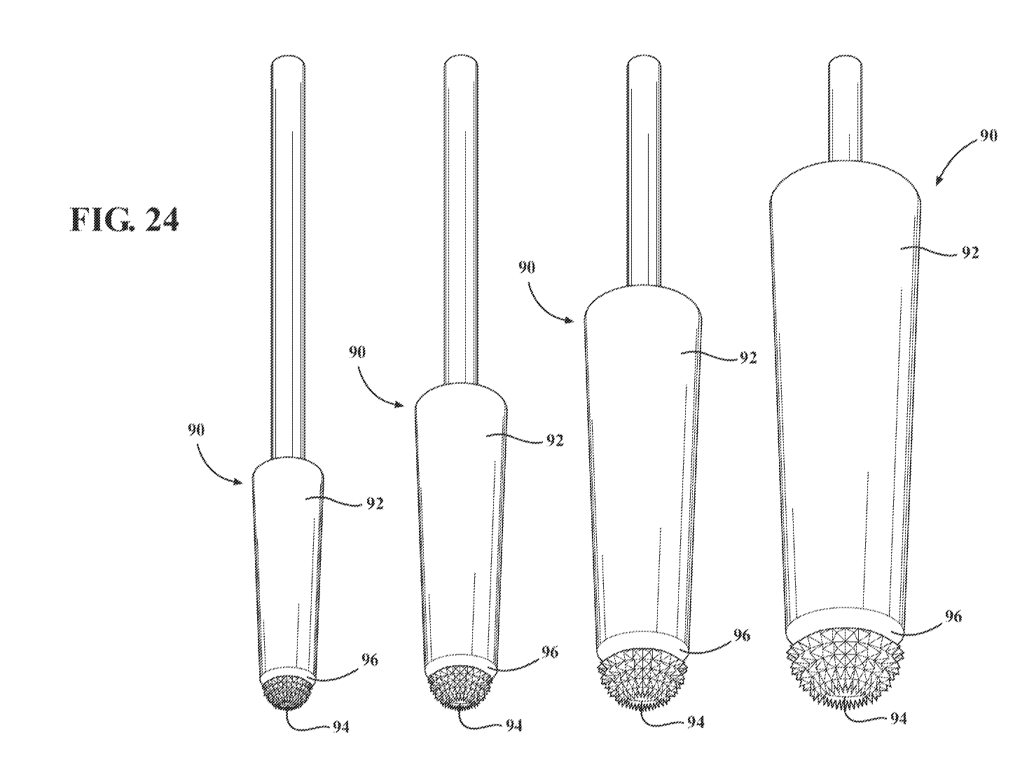

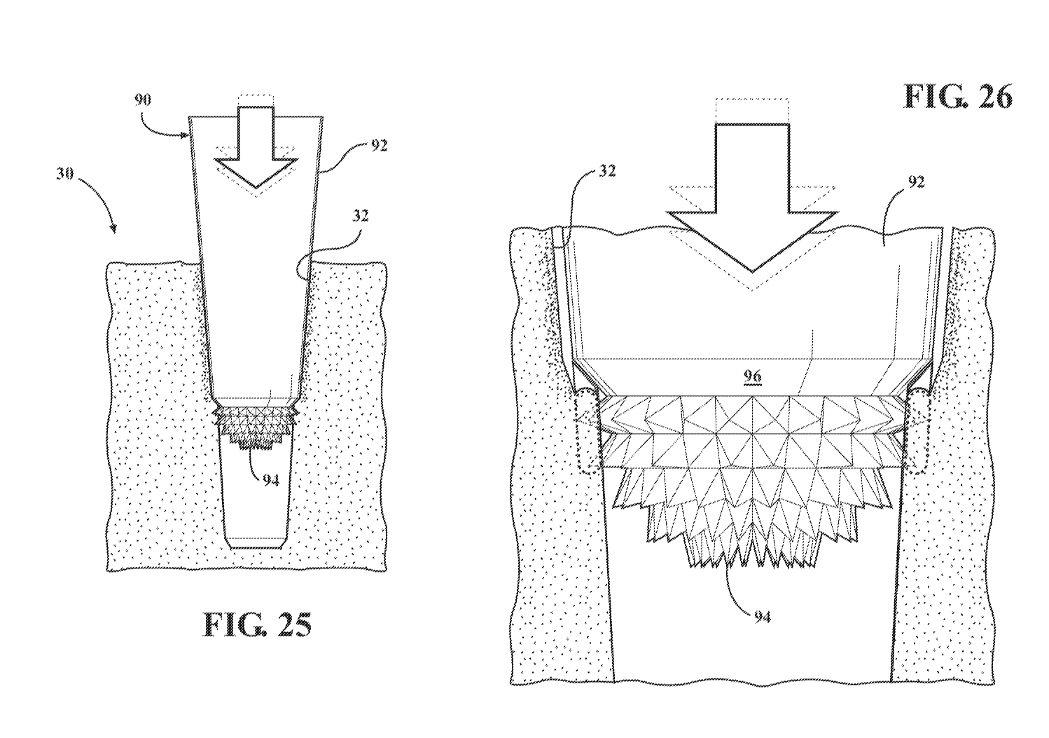

FIGS. 24-26 illustrate an alternative embodiment of this invention, namely an ultrasonic osteotome 90 configured to enlarge an osteotomy without rotation. The ultrasonic osteotome 90 includes a shank and an adjoined body 92. The body 92 having an apical end 94 remote from the shank. The body 92 is generally smooth (i.e., non-fluted) and has a conically tapered profile decreasing from a maximum diameter adjacent the shank to a minimum diameter adjacent the apical end 94. The overall proportion and dimensions of the body 92 will be similar to those of the body 42 in the preceding examples. The apical end 94 includes a unidirectional grinding formation that may take the form of a roughed surface. As the ultrasonic osteotome 90 is vibrated at a high frequency (as by a commercial off-the-shelf surgical ultrasonic generator) the apical end 94 has the effect of grinding some small portion of bone in a manner not too dissimilar from that of the apical end 48 in the earlier embodiments. The body 92 further includes an auto-grafting ramp 96 configured to auto-graft and compact bone after the bone has been ultrasonically pulverized by the apical end 94 as the body is forcibly advanced into an osteotomy concurrently with high-frequency vibration. In this example, the auto-grafting ramp 96 is a frusto-conical member disposed immediately below the smooth tapered portion of the body 92. The auto-grafting ramp 96 extends at a first angle that is larger than the taper of the body 92 so that the granular bone debris will be packed into the surrounding walls of the osteotomy with wedge-like action. Of course, it is possible to combine the rotary osteotome principles of FIGS. 1-21 with the ultrasonic osteotome principles of FIGS. 24-26 into a hybrid device. It is envisioned that such a hybrid osteotome device (not shown) may include an ultrasonic tip with a rotating body. That is to say, the autografting attributes of the apical end may be mated with the rotary densifying edges to provide a fast and efficient means by which an osteotomy may be formed according to the principles of this invention, and in particular to leverage the hydrodynamic attributes described below.

FIGS. 27-27B are intended to illustrate, for the benefit of the skilled artisan, that the principles of this invention are not limited to dental applications, but any bone preparation site within the human (or animal) body may be investigated for suitability. Initial indications reveal that applications in the vertebrae and hand/wrist are prime candidates for the bone densifying techniques of this invention due to its potential for universally applicable increases in implant primary stability, auto-grafting benefits, and inherent similarity to prior art preparation techniques.

Furthermore, as shown in FIG. 28 the principles of this invention are not limited to bone as the host material. Indeed, the rotary tool 36 of this invention may be configured to enlarge a hole in almost any type of cellular or solid material by densifying. In this illustration, a section of metal foam 98 may be of the type used extensively in aerospace, heat shielding and other critical applications. The foam metal is shown including a hole 100 formed by densifying according to the methods described above. The resulting hole 100 is better prepared to receive a screw or other fixation anchor because its inner sidewall has been densified by the compressive displacement and auto-grafting effects of this invention. Some experimentation has been made as well with hole formation in non-cellular inorganic materials like plate aluminum and plastic. Certain benefits have presented as well in these non-cellular materials, such that the potential to improve screw or anchor retention by hole preparation using the principles of this invention are fully contemplated.

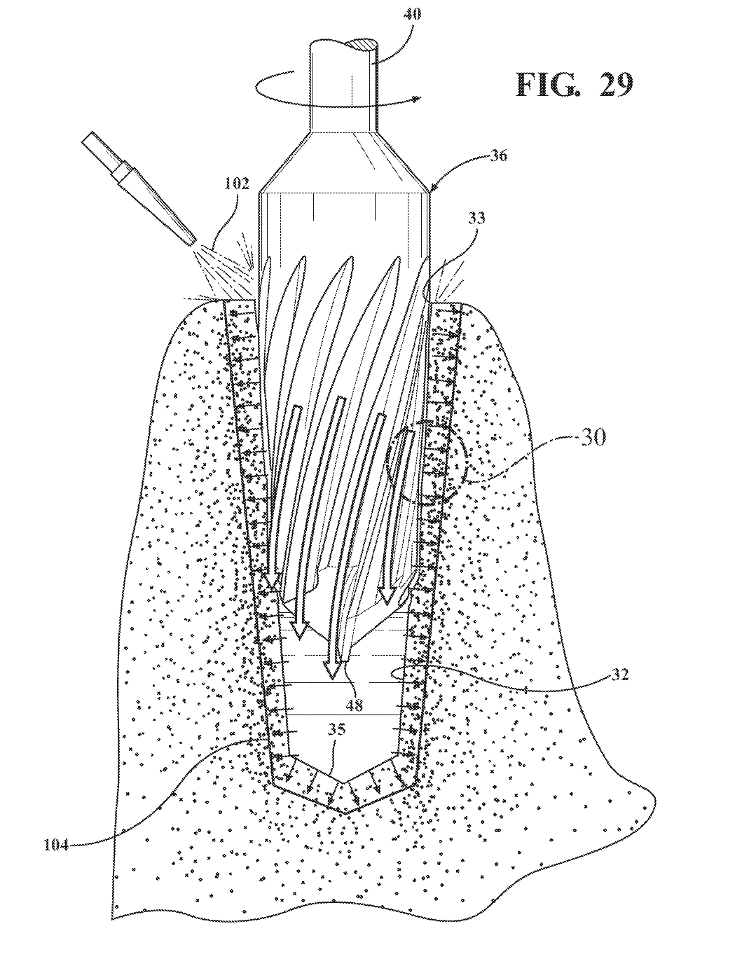

Referring now to FIGS. 29-32, an enhanced operational mode of the present invention will be described when combined with a continuous flow of irrigation fluid 102, such as by an irrigation hand piece. The irrigation fluid is preferably an incompressible liquid like sterile saline solution or water, however other suitable liquids could be used instead.

FIG. 29 corresponds, generally, to FIGS. 7 and 11 as described in detail above but with a particular distinction—the working edges 72 of the osteotome 36 are slightly separated from the inner sidewall of the osteotomy 32 as occurs frequently while practicing the controlled “bouncing” technique described above. When a continuous flow of irrigating fluid 102, e.g., water, saline or other suitable liquid, is provided, the reverse twist of the flutes 62 (vis-à-vis the rotational direction of the tool 36) will have the effect of propelling and pumping the irrigation fluid 102 down toward the bottom of the osteotomy 32. That is, the flutes 62 transport the irrigating fluid something akin to the vanes of a screw pump. As a result, irrigating fluid 102 is forcefully driven toward the bottom 35 of the precursor hole throughout the surgical procedure. This pumping or propelling action is depicted by the downwardly twisting arrows in FIG. 29.

Excess irrigation fluid 102 is continually pushed out of the osteotomy 32 in the circular gap around the osteotome 36. (It will be appreciated that when the tool 36 is used in non-medical applications, instead of an osteotomy 32 the tool 36 is placed in the entrance to a hole 100 in the surface of a host material.) Thus, so long as the flow of irrigating fluid 102 is maintained and the osteotome 36 is rotated inside the osteotomy 32, a hydraulic pressure is created that pushes outwardly upon the inner sidewalls of the osteotomy 32. A generally uniform pressure gradient 104 in the irrigating fluid is illustrated by radiating arrows. The pressure gradient pushes against the bone side walls at all times during the surgical procedure, preparing and preconditioning the interior surface of the precursor hole prior to the enlarging step.

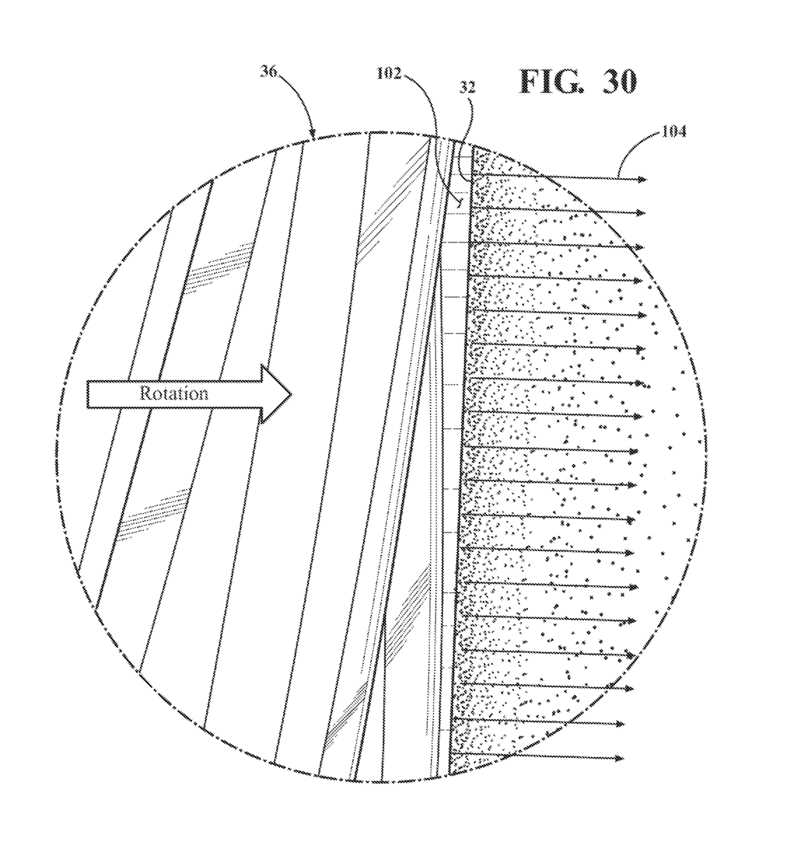

When the tapered osteotome 36 is held (by the surgeon) so that its working edges 72 are maintained in separation from the inner side walls of the osteotomy 32, the propelled hydrating pressure (created by the downward pumping action of the flutes 62) will be generally equally distributed across the entire inner surface of the osteotomy 32 according to the general principles of static hydraulics and fluid dynamics. As the surgeon moves the rotating osteotome 36 deeper into the osteotomy 32 but still its working edges 72 do not directly contact the inner side walls of the osteotomy 32, as shown for example in FIGS. 29 and 30, the hydraulic pressure will increase within the osteotomy 32. Excess irrigation fluid 102 continues to be exhausted out of the osteotomy 32 but through a smaller circular gap around the osteotome 36.

The pressure gradient 104 will thus increase and decrease in direct response to the amount of force applied by the surgeon as he or she repeatedly advances and relaxes the rotating osteotome 36 into the osteotomy 32. The pressure gradient 104 will be smallest when the osteotome 36 is held far away from the side walls of the osteotomy 32; and conversely will be largest when the working edges 72 of the osteotome 36 are pushed hard into the side walls of the osteotomy 32. By modulating the position of the osteotome 36 in combination with a continuous supply of irrigation fluid 102, the surgeon can apply an evenly distributed, expansive pressure with piston-like effect to the inner side walls of the osteotomy 32—without physically touching the walls of the osteotomy 32 with the working edges 72. This throbbing hydraulic effect has many preconditioning advantages including: 1) gentle pre-stressing of the bone structure of the osteotomy 32 in preparation for subsequent densifying contact, 2) haptic feedback transmitted through the osteotome 36 that allows the surgeon to tactically discern the instantaneously applied pressure prior to actual contact between the osteotome 36 and side walls, 3) enhanced hydration of the bone structure which increases bone toughness and increases bone plasticity, 4) hydraulically assisted infusion of bone fragments 80 into the lattice structure of the surrounding bone, 5) reduced heat transfer, 6) hydrodynamic lubricity, 7) dampening or cushioning of the trauma sensed by the patient, and so forth.

With regard to the haptic feedback advantages, the pressurized irrigation fluid 102 will have a significant amplifying effect as compared to an imagined scenario in which no irrigating fluid is used. In the latter hypothetical, haptic feedback is produced solely by the direct physical contact between the bone sidewalls and the working edges 72 and lips 50. When the surgeon “bounces” the osteotome in use, haptic feedback would abruptly stop the moment there is a separation between the bone sidewalls and the working edges 72 and lips 50. However, with irrigating fluid 102 the haptic feedback is augmented by reaction forces all along the apical tip 48 as well as by the pressure gradient 104 that surrounds the osteotome 36 even when there is a slight separation between the bone sidewalls and the working edges 72 and lips 50 as in the example of FIG. 30.

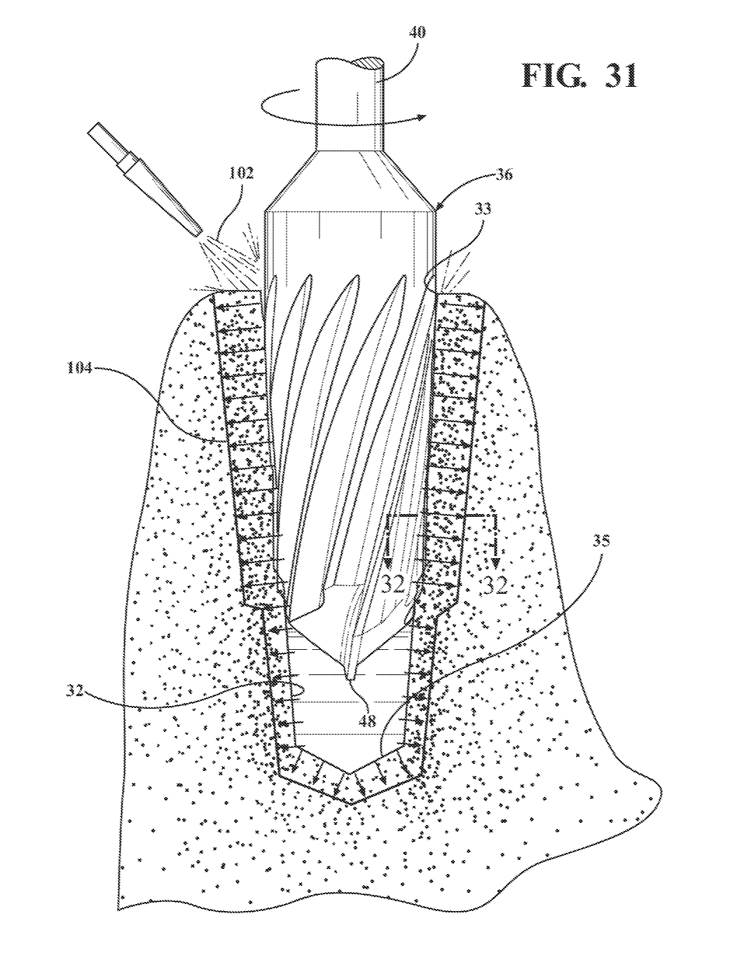

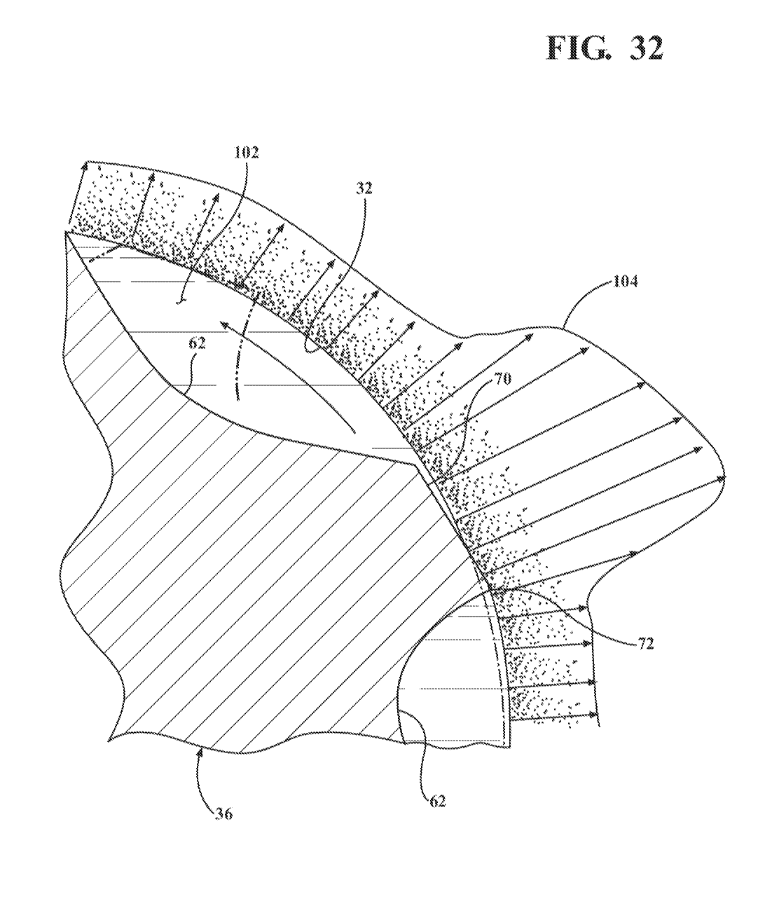

FIG. 31 depicts, graphically, the pressure gradient 104 as exerted against the inner side walls of the osteotomy 32 when the surgeon brings the working edges 72 of the spinning osteotome 36 into direct contact with the bone side walls. Arrows radiating normally from the side walls of the osteotomy 32 continue to represent the pressure gradient 104. When the working edges 72 of the osteotome 36 breach the hydrodynamic buttressing layer, they will fulfill the densifying action described in detail above. In the region of direct contact, the pressure gradient 104 will experience a sharp increase as a result of mechanically applied pressure through the working edges 72, which in turn causes the bone structure to plastically deform. Meanwhile, the irrigating fluid 102 trapped below the osteotome 36 will continue to apply a preconditioning hydro-static pressure below the apical tip 48 of the osteotome 36. By axially stroking the rotating body 42 within the precursor hole 32, the hydraulic pressure inside the precursor hole will modulate in direct response to the surgeon's movements. And so, in practice a surgeon will repeatedly apply and relax force on the continuously rotating osteotome 36 to progressively advance the osteotome 36 deeper and deeper toward its bottom 35 until a desired final depth is reached. The hydraulic assist provided by the irrigating fluid 102 enables a much cooler, faster, smoother and controllable expansion procedure. Furthermore, the dampening effect provided by the hydraulic action of the irrigating fluid 102 helps to cushion the patient's sensation of force applied by the surgeon, thereby resulting in a more comfortable experience.

FIG. 32 represents a horizontal cross-section through the osteotomy 32, as taken generally along lines 32-32 in FIG. 31. FIG. 32 offers a snap-shot of the instantaneous pressure gradient 104 around one working edge 72 of the osteotome 36. As can be readily see from this view, the instantaneous pressure gradient 104 will be relatively low in the region of the flutes 62. It may be expected that the instantaneous pressure gradient 104 in the region of the flutes 62 will be close in value to the pressure gradient below the apical tip 48 of the osteotome 36. However, the pressure quickly increases, i.e., spikes, as the land face 70 acts like a wedge to quickly compress the fluid 102 in advance of the working edge 72. The irrigating fluid 102 trapped between the land face 70 and the inner wall of the osteotomy 32 acts as a high-pressure cushion layer always ahead of (i.e., leading) the working edge 72, and together act vigorously on the bone structure of the osteotomy 32 to expand its diameter and produce a buttressing layer (Densification Crust) in bone (or a Hardening Crust in case of metals and other non-bone host materials). The working edges 72, which perpetually trail the high-pressure cushion layer during rotation in the non-cutting direction, break through the cushion layer to make direct contact with the bone side walls when enough downward force is applied by the surgeon.

When direct bone-to-edge contact is made, the working edges 72 perform the densifying action described above to simultaneously expand the osteotomy 32 and create the Densification Crust (buttressing layer) in the bone side walls. However, as soon as the surgeon lifts the osteotome 36 even a little, more irrigating fluid 102 washes over the just-densified surface. Therefore, when the surgeon gently lifts the osteotome 36 up after having made some expansion progress, a wash of pressurized irrigating fluid 102 immediately enhances hydration of the bone structure, gently pre-stresses the bone structure in preparation for further densifying by the working edges 72, hydraulically infuses bone fragments 80 into the lattice structure of the surrounding bone, cools the interface, and so forth. This cycle may repeat many times as the surgeon gently bounces the rapidly spinning osteotome 36 toward final depth. In many cases, the surgeon will bounce the spinning osteotome 36 into and out of contact with the bone sidewall some 5-20 times before reaching the bottom 35. With each bounce, the hydraulic pressure is used to precondition the osteotomy 32 and thereby improve both performance and results.

The method of this invention therefore including the step of preconditioning the interior surface of the precursor hole 32 prior to the above-described enlarging step. The preconditioning step includes building hydraulic pressure inside the precursor hole 32 between the apical tip 48 and the bottom 35 by the propelling the incompressible liquid 102 in-between the flutes 62 of the high-speed rotating osteotome 36 toward the bottom of the precursor hole 32. The hydraulic pressure can be modulated inside the precursor hole 32 in direct and somewhat proportional response to the step of axially stroking the rotating body 42 within the precursor hole 32. The preconditioning step further includes generating an elevated hydrodynamic pressure spike immediately upstream of, that is in the angular direction of rotation, of the working edge 72. The generating step further includes locating the pressure spike radially outwardly from the land face 70 of each land 68. As shown graphically in FIG. 32, the hydrodynamic pressure spike is less than the mechanical pressure generated in the host material by direct physical contact of the working edge 72, but greater than the pressure gradient in the pockets of the flutes 62.

The present invention, when operated with a continuous supply of irrigating fluid 102, may be used to form holes in many different types of materials in addition to bone. For examples, malleable metals (e.g., aluminum) or plastics may be used at the host material. When the non-bone host material is cellular, like in the case of foam metals, the host material will be expected to behave much like bone. However, when the host material in not cellular but rather solid, displaced stock will have a tendency to mound above and below the hole rather than being auto-grafted into the sidewalls of the hole 100. This mounding represents malleable material that is plastically displaced by the compression wave of the working edge 72, and further enhanced overall by the aforementioned hydraulic assistance. As a result, the effective stock thickness around a hole formed in non-cellular material will be substantially greater than the original stock thickness.

Accordingly, the present invention may be used in non-medical applications as a tool and method of hydrodynamic densifying. Advantages and benefits of hydrodynamic densifying include low plastic deformation due to rolling and sliding contact with rotating tool 36. Hydrodynamic densifying occurs with a tool 36 that has working edges 72 to densify or burnish the side walls of the hole as it is drilled into. Lubrication/irrigation is provided to eliminate overheating and to create a viscose hydrodynamic layer of densification, among many other advantages. Hydrodynamic densifying occurs when the load is well controlled beneath the ultimate strength. Hydrodynamic densifying occurs where a large negative rake angle (non-cutting edge) is used as a densifying edge. While regular twist drills or straight fluted drills have 2-3 lands to guide them through the hole, hydrodynamic densifying drills preferably have 4 or more lands and flutes.

Although no example is shown, those of skill in the art will appreciate that the osteotome of this invention could be configured with a straight or non-tapered body rather than the tapered working end as shown in the illustrations. Accordingly, the described osteotomy enlargement techniques can be accomplished using non-tapered tools via the novel method of densifying in combination with hydrodynamic effects.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A method for enlarging a hole in a host material in preparation for an anchor, said method comprising the steps of:
providing a precursor hole in a host material, the precursor hole having an interior surface extending between an entrance and a closed bottom,
providing a rotary tool configured to be turned at high speed, the tool including a body having an apical end, a plurality of flutes disposed about the body, a land formed between each two adjacent flutes, each land having a land face leading into a working edge that is fixed relative to the body at a negative rake angle when the tool is rotated in a non-cutting direction,
rotating the body of the tool in a non-cutting direction greater than 200 RPM,
inserting the apical end of the rotating body into the entrance of the precursor hole,
irrigating the precursor hole with a substantially incompressible liquid,
enlarging the precursor hole by forcibly pushing the rotating body toward the bottom of the precursor hole, said enlarging step including sweeping the working edges in the non-cutting direction against the interior surface of the precursor hole without cutting the host material to plastically deform the host material in a full circular and progressively descending manner beginning at the entrance and developing toward the bottom, and
hydraulically preconditioning the host material within the precursor hole prior to contact with a working edge during said sweeping step.

2. The method of claim 1 wherein said hydraulically preconditioning step includes forcefully propelling the incompressible liquid in-between the flutes toward the bottom of the precursor hole.

3. The method of claim 2 wherein said enlarging step includes axially stroking the rotating body within the precursor hole to modulate the intensity of the hydraulic pressure inside the precursor hole.

4. The method of claim 2 wherein said preconditioning step includes generating an elevated hydrodynamic pressure spike against the host material immediately prior to contact with each respective working edge.

5. The method of claim 4 wherein said step of generating an elevated hydrodynamic pressure spike includes locating the pressure spike radially outwardly from the land face that leads to the respective working edge.

6. The method of claim 2 wherein the interior surface of the precursor hole has a conically tapered sidewall extending between the entrance and the bottom, and wherein the entrance has a larger diameter than the bottom, and the body of the tool is conically tapered.

7. The method of claim 6 wherein the working edge of each land has a helical twist that turns away from the non-cutting direction as the conically tapered profile decreases in diameter.

8. The method of claim 1 wherein the host material has an open cellular composition.

9. The method of claim 8 wherein bottom of the precursor hole is closed by the host material, the bottom having a generally conical shape.

10. The method of claim 1 further including removing the tool from the expanded hole, and installing an anchor into the expanded hole by directly screwing an exterior thread form of the anchor into the expanded hole formed by the working edges.

11. A method for enlarging an osteotomy in a bone in preparation for an implant or fixture, said method comprising the steps of:
providing a precursor osteotomy in bone, the precursor osteotomy having an interior surface extending between an entrance and a closed bottom,
providing a rotary osteotome configured to be turned at high speed, the osteotome including a body having an apical end, a plurality of flutes disposed about the body, a land formed between each two adjacent flutes, each land having a land face leading into a working edge,
rotating the body of the osteotome in a non-cutting direction greater than 200 RPM,
inserting the apical end of the rotating body into the entrance of the precursor osteotomy,
irrigating the precursor osteotomy with a substantially incompressible liquid,
enlarging the precursor osteotomy by forcibly pushing the rotating body toward the bottom of the precursor osteotomy, said enlarging step including sweeping the working edges in the non-cutting direction against the interior surface of the precursor osteotomy without cutting the bone to plastically deform the bone in a full circular and progressively descending manner beginning at the entrance and developing toward the bottom, and
hydraulically preconditioning the bone within the precursor osteotomy prior to contact with a working edge during said sweeping step.

12. The method of claim 11 wherein said hydraulically preconditioning step includes forcefully propelling the incompressible liquid in-between the flutes toward the bottom of the precursor osteotomy.

13. The method of claim 12 wherein said enlarging step includes axially stroking the rotating body within the precursor osteotomy to modulate the intensity of the hydraulic pressure inside the precursor osteotomy.

14. The method of claim 12 wherein said preconditioning step includes generating an elevated hydrodynamic pressure spike against the bone immediately prior to contact with each respective working edge.

15. The method of claim 14 wherein said step of generating an elevated hydrodynamic pressure spike includes locating the pressure spike radially outwardly from the land face that leads to the respective working edge.

16. The method of claim 12 wherein the interior surface of the precursor osteotomy has a conically tapered sidewall extending between the entrance and the bottom, and wherein the entrance has a larger diameter than the bottom, and the body of the osteotome is conically tapered.

17. The method of claim 16 wherein the working edge of each land has a helical twist that turns away from the non-cutting direction as the conically tapered profile decreases in diameter.

18. The method of claim 11 wherein bottom of the precursor osteotomy is closed by the bone, the bottom having a generally conical shape.

19. The method of claim 11 further including removing the osteotome from the expanded osteotomy, and installing an implant or fixture into the expanded osteotomy by directly screwing an exterior thread form of the implant or fixture into the expanded osteotomy formed by the working edges.

20. A method for enlarging a hole in a host material in preparation for an implant or fixture, said method comprising the steps of:
providing a precursor hole in a host material, the precursor hole having an interior surface extending between a generally circular entrance and a bottom closed by the host material,
providing a rotary osteotome configured to be turned at high speed in one continuous non-reversing direction, the osteotome comprising: a shank and a body joined to the shank, the body having an apical end remote from the shank, the body having a conically tapered profile decreasing from a maximum diameter adjacent the shank to a minimum diameter adjacent the apical end, the apical end including a pair of lips, a plurality of flutes disposed about the body, the flutes having a helical twist, each flute having a densifying face and an opposing cutting face, a plurality of lands, each land formed between two adjacent flutes, each land having a land face joining a densifying face of one the flute and a cutting face of an adjacent the flute, each land face intersecting the respective the cutting face along a working edge, the working edge having a helical twist that turns away from the non-cutting direction as the conically tapered profile decreases in diameter,
rotating the body of the osteotome greater than about 200 RPM,
inserting the apical end of the rotating body into the entrance of the precursor hole,
irrigating the precursor hole, said irrigating step including applying a stream of a substantially incompressible liquid onto the rotating body adjacent the entrance,
enlarging the precursor hole by forcibly pushing the rotating body into the precursor hole so that the working edges sweep against the interior surface of the precursor hole to gently expand the precursor hole by incremental plastic deformations that cause a progressive enlargement of the precursor hole beginning adjacent the entrance and developing in a frustoconical pattern downwardly into the precursor hole, said enlarging step including axially stroking the rotating body within the precursor hole so that the working edges lap against the bone interior surface with downward motion and then separate from the interior surface with upward motion in ever deepening movements that cause a progressive plastic deformation of the interior surface of the precursor hole beginning adjacent the entrance and developing toward the bottom, and
building hydraulic pressure inside the precursor hole between the apical tip and the bottom by propelling the incompressible liquid in-between the flutes toward the bottom of the precursor hole, modulating the hydraulic pressure inside said precursor hole in direct response to said step of axially stroking the rotating body within the precursor hole, and generating an elevated hydrodynamic pressure spike immediately in front of the working edge.
